(19) United States
(12) Patent Application Publication
(10) Pub. No.: US 2011/0090439 A1
(43) Pub. Date: Apr. 21, 2011

(54) Retardation film, polarizing plate and liquid crystal display device

(75) Inventors: Shun Nakamura, Kanagawa (JP); Kentaro Toyooka, Kanagawa (JP); Shigeaki Nimura, Kanagawa (JP); Hiroshi Sato, Kanagawa (JP)

(73) Assignee: FUJIFILM Corporation, Tokyo (JP)

(21) Appl. No.: 12/923,926

(22) Filed: Oct. 14, 2010

(30) Foreign Application Priority Data
Oct. 16, 2009 (JP) 2009-239143
Nov. 18, 2009 (JP) 2009-262598
May 25, 2010 (JP) 2010-119854

(51) Int. Cl. G02F 1/1335

(52) U.S. Cl. 349/117

(57) ABSTRACT

A retardation film comprising a transparent support, disposed on a surface thereof, an alignment layer and an optically anisotropic layer is disclosed. The transparent support and the optically anisotropic layer satisfy following relations:

Re(DLC)<60 nm (1)

(−0.5)×Re(TS)+40≦Re(DLC)≦(−0.5)×Re(TS)+80 (2)

0.5×Rth(TS)−10≦Re(DLC)≦0.5×Rth(TS)+30 (3)
where Re(DLC) indicates retardation in plane of the optically anisotropic layer; Re(TS) indicates retardation in plane of the transparent support; and Rth(TS) indicates retardation along the thickness direction of the transparent support.

### CROSS-REFERENCE TO RELATED APPLICATIONS

The present application claims the benefit of priority from Japanese Patent Applications No. 2009-239143, filed on Oct. 16, 2009, No. 2009-262598, filed on Nov. 18, 2009, and No. 2010-119854, filed on May 25, 2010, the contents of which are herein incorporated by reference in their entirety.

### BACKGROUND OF THE INVENTION

1. Field of the Invention

The present invention relates to a retardation film capable of contributing to improvement of panel-qualities of liquid crystal display devices, especially TN-mode liquid crystal display devices, and a polarizing plate and a liquid crystal device having the same.

2. Related Art

Liquid crystal display devices are more and more used in television sets; and their screens are getting larger and larger. The demands on higher display-qualities are increased. Especially, the contrast ratio (frontal CR), which is obtained when the panel is viewed in the front direction (along the direction normal to the displaying plane), and the contrast ratio (viewing-angle CR), which is obtained when the panel is viewed in the oblique direction, are important; and their improvement has been studied variously. For example, as described in JP-A-08-50206, a retardation film comprising a support and, thereon, an optically anisotropic layer formed of hybrid-aligned discotic liquid crystal, which is capable of improving the viewing-angle contrast ratio of a TN-mode liquid crystal display device, was proposed. Other retardation films having the similar constitution were also proposed (for example, JP-A-2000-249835 and JP-A-2002-122736).

However, employing the retardation film having such a constitution contributes to increasing the viewing-angle CR, and, on the other hand, contributes to decreasing the frontal CR adversely.

### SUMMARY OF THE INVENTION

As a result of assiduous studies, the present inventors have found that the alignment of discotic liquid crystal in the optically anisotropic layer, which is used for optical compensation of incident light in a liquid crystal display device, has very minor disarray, and the very minor disarray causes light scattering, which increases brightness leakage of the film and decreases the frontal CR.

One object of the present invention is to provide a retardation film and a polarizing plate which are capable of contributing to improvement of the viewing angle CR without decreasing the frontal CR.

Another object of the invention is to provide a liquid crystal display device (especially a TN-mode liquid crystal display device), having high frontal CR and high viewing angle CR, excellent in displaying qualities.

As a result of assiduous studies, the present inventors have found the retardation film capable of optical compensation for incident light in the oblique directions without lowering the brightness of the film; and found also that it is possible to provide liquid crystal display devices improved in not only the viewing angle CR but also the frontal CR by employing the retardation film.

The means for achieving the objects are as follows.

[1] A retardation film comprising a transparent support, disposed on a surface thereof, an alignment layer and an optically anisotropic layer;

wherein the optically anisotropic layer is formed of a hybrid-aligned liquid crystal composition containing at least one discotic liquid crystal compound;

the averaged tilt angle of discotic molecules of the at least one discotic liquid crystal compound at the alignment-layer interface side of the optically anisotropic layer is equal to or larger than 45°;

the averaged tilt angle of discotic molecules of the at least one discotic liquid crystal compound at the air-interface side of the optically anisotropic layer is equal to or smaller than 45°; and

the transparent support and the optically anisotropic layer satisfy following relations:

Re(DLC)<60 nm (1)

(−0.5)×Re(TS)+40≦Re(DLC)≦(−0.5)×Re(TS)+80 (2)

0.5×Rth(TS)−10≦Re(DLC)≦0.5×Rth(TS)+30 (3)

where Re(DLC) represents retardation in plane of the optically anisotropic layer; Re(TS) represents retardation in plane of the transparent support; and Rth(TS) represents retardation along the thickness direction of the transparent support.

[2] The retardation film of [1], wherein the minor distribution in alignment axes is equal to or smaller than 4.
[3] The retardation film of [1] or [2], wherein the transparent support is a cellulose acylate film; and the in-plane slow axis of the transparent support is perpendicular to the mechanical direction thereof.
[4] A polarizing plate comprising a polarizing film and a retardation film of any one of [1]-[4].
[5] The polarizing plate of [4], wherein the in-plane slow axis of the retardation films is parallel to the transmission axis of the polarizing film.
[6] A liquid crystal display device comprising a retardation film of any one of [1]-[3] and/or a polarizing plate of [4] or [5].
[7] The liquid crystal display device of [6], comprising a liquid crystal cell comprising:

a pair of substrates disposing face to face, at least one of them having an electrode thereon;

a liquid crystal layer disposed between the pair of substrates; and

a color filter in which at least three pixels, having a different main transparent wavelength from each other, are disposed,

wherein the thickness of the liquid crystal layer is different between at least two of the pixels. By employing the retardation film or the polarizing plate of the present invention, it is possible to provide a liquid crystal display device (especially a TN-mode liquid crystal display device), having high frontal CR and high viewing angle CR, excellent in displaying qualities.

### DETAILED DESCRIPTION OF THE INVENTION

The invention is described in detail hereinunder.

In this description, the numerical range expressed by the wording “a number to another number” means the range that falls between the former number indicating the lowermost limit of the range and the latter number indicating the uppermost limit thereof.

In this description, the numerical data, the numerical range and the qualitative expression (for example, “equivalent”, “same”, etc.) indicating the optical characteristics of component parts such as retardation film, liquid-crystal layer and others should be so interpreted as to indicate the numerical data, the numerical range and the qualitative expression that include the error range generally acceptable for liquid-crystal display devices and their component parts. It is to be noted that “45°”, “parallel” and “perpendicular” in the context of this specification allow a tolerance of less than ±5° with respect to the precise angles. Difference from the precise angles is preferably less than 4°, and more preferably less than 3°.

With respect to the angles, “+” corresponds to the clockwise direction, and “−” corresponds to the counter-clockwise direction.

The “slow axis” means the direction in which the refractive index becomes maximum. The measurement wavelength for the refractive index is A=550 nm in the visible light region, unless otherwise specifically noted.

In the description, the terms of “polarizing plate” means not only polarizing plates having a proper size to be employed in a liquid-crystal but also long polarizing plates before being cut. And in the specification, the terms of “polarizing film” is distinct from the term “polarizing plate”, and the term of “polarizing plate” is used for any laminated body comprising a “polarizing film” and at least one protective film thereon.

In the description, the terms of “molecular symmetry axis” as used herein means a rotational symmetry axis in the case of a molecule having the rotational symmetry axis. However, it is not required that a molecule has rotational symmetry in a strict meaning. In a discotic liquid crystal compound, the molecular symmetry axis generally agrees with an axis which perpendicularly penetrates the disc face at the center thereof. In a rod-shaped liquid crystal molecule, the molecular symmetry axis agrees with the long axis of its molecule.

In this description, Re(λ) and Rth(λ) are an in-plane retardation (nm) and a thickness-direction retardation (nm), respectively, at a wavelength of λ. Re(λ) is measured by applying light having a wavelength of λ nm to a film in the normal direction of the film, using KOBRA 21ADH or WR (by Oji Scientific Instruments). The selectivity of the measurement wavelength λ nm may be conducted by a manual exchange of a wavelength-filter, a program conversion of a measurement wavelength value or the like. When a film to be analyzed by a monoaxial or biaxial index ellipsoid, Rth(λ) of the film is calculated as follows. It is to be noted that the following method is partially used for measuring the averaged tilt angles of discotic liquid crystal molecules aligned at the alignment-layer side and the other side in an optically anisotropic layer

Rth(λ) is calculated by KOBRA 21ADH or WR based on six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane); a value of hypothetical mean refractive index; and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR.

Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to the following formulae (A) and (B):

$$\begin{matrix}Re ( θ ) = [ nx - \frac{ny \times nz}{\sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}}} ] \times \frac{d}{cos \{ {sin}^{- 1} ( \frac{sin ( - θ )}{nx} ) \}} & ( A ) \\ Rth = \{ ( nx + ny ) / 2 - nz \} \times d & ( B )\end{matrix}$$

Re(e) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the sample.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59).

KOBRA 21ADH or WR calculates nx, ny and nz, upon enter of the hypothetical values of these mean refractive indices and the film thickness. Base on thus-calculated nx, ny and nz, Nz=(nx−nz)/(nx−ny) is further calculated.

And, in the description, the minor distribution in alignment axes of an optically anisotropic layer is calculated according to the following method.

Being observed at 400-fold magnification under a polarizing microscope, having polarizing plates in Crossed Nichol state, a retardation film, having an optically anisotropic layer formed of a liquid crystal composition is taken images with a digital camera while the stage is rotated by ±10 degrees at intervals of 0.5 degree relative to the position giving the darkest state. After that, the obtained digital images are subjected to a rotational and parallel displacement-treatment, so that the images are aligned accurately by the pixel unit. Then, the angle giving the darkest state is recorded by the pixel unit; and the angle giving the darkest state is plotted along the abscissa, and the number of the pixel giving the darkest state at the angle is plotted along the ordinate, which gives a histogram. The half bandwidth is calculated using the histogram. In this method, a general polarizing microscope such as ECLIPSE E600POL (by Nikon) can be used. And the rotational and parallel displacement treatment may be carried out by using a commercially available program.

And in the description, the averaged tilt angles of discotic liquid crystal molecules aligned at the alignment-layer side and the other side in an optically anisotropic layer are measured according to the following method.

Retardation of a sample film is measured, relative to the normal direction of the sample film from −50 degrees up to +50 degrees at intervals of 10 degrees, in 11 points in all with a light having a wavelength of λ nm applied in the inclined direction; and based on the thus-measured retardation values, the estimated value of the mean refractive index, the inputted sample film thickness value, and the estimated value of the tilt angle, the averaged tilt angles of the sample film may be calculated by KOBRA 21ADH or WR.

### (Retardation Film)<

### <Constitution of Retardation Film>

A retardation film of the present invention comprises a transparent support, disposed on a surface thereof, an alignment layer and an optically anisotropic layer. More specifically, the retardation film may have a transparent support, an alignment layer and an optically anisotropic layer in this order; and for lamination thereof, coating, sticking or transferring may be used.

### <<Optically Anisotropic Layer>>

The retardation film of the present invention comprises the optically anisotropic layer formed of a liquid crystal composition disposed on the transparent support. The optically anisotropic layer may be formed on an alignment layer formed previously on the transparent support. And the optically anisotropic layer may be formed on a temporary support, and then transferred onto the transparent support with a adhesive agent or the like. The temporary support may be transparent or not transparent.

Examples of the liquid crystal compound which can be used for preparing the optically anisotropic layer include discotic liquid crystal compounds. High-molecular weight or low-molecular weight liquid crystals may be used. Low-molecular weight liquid crystals exhibiting no liquid crystallinity after being crosslinked may be also used.

### [Discotic Liquid Crystal Compound]

Examples of discotic liquid crystals are described in various documents and include benzene derivatives described in a research report by C. Destrade et al. (Mol. Cryst. Vol. 71, page 111 (1981); torxene derivatives described in a research report by C. Destrade et al., Mol. Cryst. Vol. 122, page 141 (1985), Physics lett, A, Vol. 78, page 82 (1990); cyclohexane derivatives described in a research report by B. Kohne et al. Angew. Chem., Vol. 96, page 70 (1984), azacrown based and phenyl acetylene based macrocycles described in research reports by M. Lehn et al. (J. Chem. Commun., page 1794 (1985) and J. Zhang et al., J. Am. Chem. Soc. Vol. 116, page 2655 (1994).

Examples of the discotic compound include compounds having a core and radial side chains of straight alkyl, alkoxy, or substituted benzoyloxy groups. The discotic compound is preferably such a compound that exhibits a rotation symmetry in the state of a molecule or a molecular assembly to be in an alignment.

In the optically anisotropic layer, the discotic compound is not required to exhibit liquid crystalline properties finally. For example, the discotic compound may be a low-molecular discotic compound having a heat- or light-responsive group, which shows no liquid crystalline properties after the compound is aligned into a predetermined state, polymerized or crosslinked by applying heat or light, and fixed to the alignment state.

Preferred examples of the discotic compounds include those described in JP-A No. 8-50206, JP-A No. 2006-76992, [0052], and JP-A No. 2007-2220, [0040]-[0063]. The compounds represented by formula (DI) and (DII) are preferable since they may have high birefringence. Furthermore, among the compounds represented by formula (DI) and (DII), the compounds exhibiting discotic liquid crystallinity are more preferable, and especially, the compounds exhibiting discotic nematic liquid crystallinity are even more preferable. The details (the meaning of the symbols in the formulas and the preferable examples thereof) of the compounds represented by the following formulas are described in the above-mentioned documents.

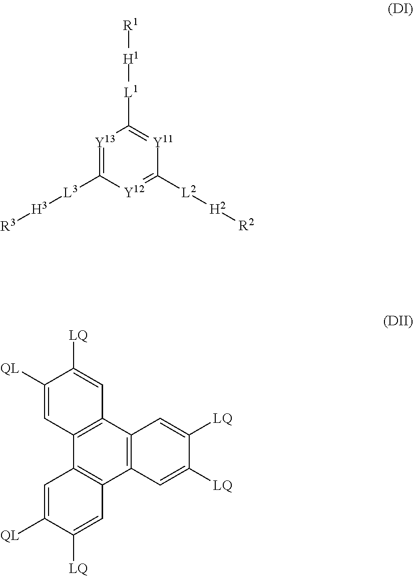

And preferable examples of the discotic liquid crystal compounds include also those described in JP-A No. 2005-301206.

The optically anisotropic layer may be prepared as follows. A composition containing at least one liquid crystal compound is disposed on a surface (for example, the surface of an alignment layer); molecules of the liquid crystal compound are aligned in a desired alignment state; and then the polymerization of the composition is carried out, so that the alignment is fixed and then, the optically anisotropic layer is obtained. The alignment state to be fixed is preferably a hybrid alignment state. The term of “hybrid alignment” means an alignment state in which directors of molecules vary along the thickness direction of the layer. Regarding discotic liquid crystal, the director thereof is vertical to the discotic face.

For aligning liquid crystal molecules in a desired state, or improving the coating- or the curing properties, one or more additives may be added to the composition. For aligning liquid crystal molecules in the hybrid alignment state, any additive capable of controlling alignment at the air interface of the layer, referred to as “agent for controlling the air interface alignment” hereinafter, may be added to the composition. Examples of such an additive include low-molecular-weight- and high-molecular-weight-compounds having a fluorinated alkyl group and a hydrophilic group such as sulfonyl. Specific examples of the additive include the compounds described in JP-A No. 2006-267171.

The composition may be prepared as a coating liquid, and the optically anisotropic layer may be formed by coating. In such a case, any surfactant may be added to the composition. Examples of the surfactant include fluorinated compounds such as those described in JP-A No. 2001-330725, [0028]-[0056]. Commercially available surfactants such as “Megafac F780” (manufactured by Dainippon Ink & Chemicals, Inc.) may be also used.

The composition is preferably curable, and in such a case, any polymerization initiator may be added to the composition. The polymerization initiator may be selected from thermal or photo-polymerization initiators. In terms of ease of controlling, photo-polymerization initiators are preferable. Examples of the photo-polymerization initiator, which is capable of generating radicals under irradiation with light, include alpha-carbonyl compounds (described in U.S. Pat. Nos. 2,367,661 and 2,367,670), acyloin ether (described in U.S. Pat. No. 2,448,828), alpha-hydrocarbon-substituted aromatic acyloin compounds (described in U.S. Pat. No. 2,722,512), polynuclearquinone compounds (described in U.S. Pat. Nos. 3,046,127 and 2,951,758), combinations of triarylimidazole dimers and p-aminophenyl ketones (described in U.S. Pat. No. 3,549,367), acridine and phenadine compounds (described in JPA No. sho 60-105667 and U.S. Pat. No. 4,239,850), oxadiazole compounds (described in U.S. Pat. No. 4,212,970), acetophenone type compounds, benzoin ether type compounds, benzyl type compounds, benzophenone type compounds, and thioxanthone type compounds. Examples of the acetophenone compound include, for example, 2,2-diethoxyacetophenone, 2-hydroxymethyl-1-phenylpropan-1-one, 4′-isopropyl-2-hydroxy-2-methyl-propiophenone, 2-hydroxy-2-methyl-propiophenone, p-dimethylaminoacetone, p-tert-butyldichloroacetophenone, p-tert-butyltrichloroacetopheone, p-azidobenzalacetophenone. Examples of the benzyl compound include, for example, benzyl, benzyl dimethyl ketal, benzyl-methoxyethyl acetal, 1-hydroxycyclohexyl phenyl ketone. The benzoin ether compounds include, for example, benzoin, benzoin methyl ether, benzoin ethyl ether, benzoin n-propyl ether, benzoin isopropyl ether, benzoin n-butyl ether, and benzoin isobutyl ether. Examples of the benzophenone compound include benzophenone, methyl o-benzoylbenzoate, Michler's ketone, 4,4′-bisdiethylaminobenzophenone, 4,4′-dichlorobenzophenone. Examples of the thioxanthone compound include thioxanthone, 2-methylthioxanthone, 2-ethylthioxanthone, 2-isopropylthioxanthone, 4-isopropylthioxanthone, 2-chlorothioxanthone, and 2,4-diethylthioxanthone. Of those aromatic ketones serving as a light-sensitive radical polymerization initiator, more preferred are acetophenone compounds and benzyl compounds in point of their curing capability, storage stability and odorlessness. One or more such aromatic ketones may be used herein as a light-sensitive radical polymerization initiator, either singly or as combined depending on the desired performance of the initiator.

For the purpose of increasing the sensitivity thereof, a sensitizer may be added to the polymerization initiator. Examples of the sensitizer are n-butylamine, triethylamine, tri-n-butyl phosphine, and thioxanthone. Plural types of the photopolymerization initiators may be combined and used herein, and the amount thereof is preferably from 0.01 to 20% by mass around of the solid content of the coating liquid, more preferably from 0.5 to 5% by mass around. For light irradiation for polymerization of the liquid-crystal compound, preferably used are UV rays.

The composition may comprise a polymerizable non-liquid crystal monomer(s) along with the polymerizable liquid crystal compound. Examples of the polymerizable monomer include compounds having a vinyl, vinyloxy, acryloyl or methacryloyl. For improving the durability, polyfunctional monomers, having two or more polymerizable groups, such as ethyleneoxide-modified trimethylolpropane acrylates maybe used. The amount of the polymerizable non-liquid crystal monomer is preferably equal to or less than 15% by mass around and more preferably from 0 to 10% by mass around with respect to the amount of the liquid crystal compound.

The optically anisotropic layer may be produced according to a method comprising applying a coating liquid, which is the composition, to a surface of an alignment layer disposed on the transparent support, drying it to remove solvent from it and align liquid crystal molecules, and then curing it via polymerization. The coating method may be any known method of curtain-coating, dipping, spin-coating, printing, spraying, slot-coating, roll-coating, slide-coating, blade-coating, gravure-coating or wire bar-coating. Drying the coating layer may be carried out under heat. During drying it, while solvent is removed from it, liquid crystal molecules therein are aligned in a preferred state. Next, the layer is irradiated with UV light to carry out polymerization reaction, and then the alignment state is immobilized to form an optically anisotropic layer. The irradiation energy is preferably from 20 mJ/cm² to 50 J/cm², more preferably from 100 mJ/cm² to 800 mJ/cm². For promoting the optical polymerization, the light irradiation may be attained under heat. The thickness of the optically anisotropic layer may be from 0.1 to 10 micro meters or from 0.5 to 5 micro meters.

The optically anisotropic layer is preferably formed by using an alignment layer. Examples of the alignment layer which can be used in the invention include polyvinyl alcohol films and polyimide films. It is preferable that the liquid crystal compound to be used in the invention expresses a liquid crystal phase showing favorable monodomain characteristics. By achieving such favorable monodomain characteristics, it becomes possible to effectively prevent a problem that a polydomain structure is formed and any orientation defect(s) arise at the boundary between domains, thereby causing light scattering. Moreover, a compound showing favorable monodomain properties is preferred, since a phase contrast plate having the same exhibits an elevated light transmittance. The liquid-crystal phase that the liquid-crystal compound to be used in the invention expresses includes a columnar phase and a discotic nematic phase (ND phase). Of those liquid-crystal phases, preferred is a discotic nematic phase (ND phase) having a good monodomain property.

According to the invention, the liquid crystal compounds having smaller wavelength dispersion characteristics are more preferable. More specifically, the liquid crystal compounds having Re(450)/Re(650) of smaller than 1.25, equal to or smaller than 1.25, or equal to or smaller than 1.15 are preferable. Re(A) of a liquid crystal means the value of retardation in plane of a layer formed of the liquid crystal at a wavelength of A nm. The liquid crystal compound to be used in the present invention preferably has the isotropic transition temperature, T₁₅₀, of from 100 to 180 degrees Celsius, of from 100 to 165 degrees Celsius, or of from 100 to 150 degrees Celsius, for being aligned on the alignment layer.

### [Optical Properties of Optically Anisotropic Layer]

The Re value of the optically anisotropic layer is preferably less than 60 nm, or more preferably from 55 to 20 nm.

The optically anisotropic layer is formed of the hybrid-aligned discotic liquid crystal composition. According the preferable embodiment of the invention, the averaged tilt angle of discotic liquid crystal molecules at the alignment layer-interface is larger than the averaged tilt angle of discotic liquid crystal molecules at the other interface. At the alignment layer interface, discotic liquid crystal (DLC) molecules are preferably inclined by a tilt angle of equal to or more than 45 degrees (that is, the averaged tilt angle is preferably equal to or more than 45 degrees), or by a tilt angle of equal to or more than 50 degrees. On the other hand, at the other interface, DLC molecules are preferably inclined by a tilt angle of equal to or less than 45 degrees (that is, the averaged tilt angle is preferably equal to or less than 45 degrees), or by a tilt angle of equal to or less than 40 degrees. In such a hybrid alignment, the hybrid alignment state may be formed stably, and may compensate incident light in oblique directions more correctly and may give higher viewing-angle CR, which is more preferable.

The state in which discotic liquid crystal (DLC) molecules are preferably inclined by a tilt angle of equal to or more than 45 degrees means the state in which the angle between the discotic faces of DLC molecules and the layer-plane is equal to or more than 45 degrees.

The means for achieving the averaged tilt angle of equal to or more than 45 degrees include adding any additive capable of controlling the tilt angle to the optically anisotropic layer, selecting the alignment layer, using oblique evaporation or photo-alignment and any combinations thereof.

### <<Alignment Layer>>

The retardation film of the invention comprises an alignment layer disposed on the transparent support. The alignment layer is used for preparing the optically anisotropic layer from the liquid crystal composition containing at least one discotic liquid crystal compound. Examples of the material of the alignment layer include polyvinyl alcohols, modified polyvinyl alcohols, polyimides, modified polyimides, acrylate monomers, methacrylate monomers, and polystyrenes, which may adjust the averaged tilt angle of the optically anisotropic layer at the alignment-layer interface to the preferred range. The examples are not limited to those exemplified above, and other materials can be used for the alignment layer as long as achieving the preferred averaged tilt angle. The copolymers described in JP-A No. 2002-98836, [0014]-[0016], especially, the copolymers described in JP-A No. 2002-98836, [0024]-[0029] and [0173]-[0180], are more preferable as the material of the alignment layer, in terms of reducing the minor distribution in alignment-axes. The copolymers described in JP-A No. 2005-99228, [0007]-[0012], especially, the copolymers described in JP-A No. 2005-99228, [0016]-[0020], are more preferable as the material of the alignment layer, in terms of reducing the minor distribution in alignment-axes. More preferably, one or more constitutive units in each of the copolymers, described in the two documents, are replaced with the unit having any polymerizable group such as vinyl group, in terms of improving the adhesion between the alignment layer and the optically anisotropic layer.

### <<Transparent Support>>

The transparent support which can be used in the invention satisfies the following relations with Re of the optically anisotropic layer, Re(DLC).

(−0.5)×Re(TS)+40≦Re(DLC)≦(−0.5)×Re(TS)+80 (2)

0.5×Rth(TS)−10≦Re(DLC)≦0.5×Rth(TS)+30 (3)

In the relations, Re(DLC) means Re of the optically anisotropic layer; Re(TS) means Re of the transparent support; and Rth(TS) means Rth of the transparent support.

As long as satisfying the relations, the materials of the transparent support are not limited, and include cellulose acylates, polycarbonates, poly(methyl acrylate) and acryl polymers. Cellulose acylates are preferable since the film satisfying the relations may be prepared easily without any stretching treatment in the transverse direction, with low cost.

In the following paragraphs, the cellulose acylate films which can be used as the transparent support in the present invention are described in detail.

### [Method for Preparing Cellulose Acylate Film]

One example of the method of preparing the cellulose acylate film, which can be used in the invention, comprises:

casting a polymer solution that comprises a plasticizer having a number-average molecular weight of from 200 to 10000 and a cellulose acylate to form a web (casting step),

stretching the web having a residual solvent amount of from 100 to 300% by mass in one direction at a temperature of from −30 degrees Celsius to 30 degrees Celsius (first stretching step),

drying the web to reduce the residual solvent amount thereof to 100% by mass or less after the beginning of the first stretching step and before the beginning of the drying step, and

after the residual solvent amount of the web is reduced to 10% by mass or less while controlling the surface temperature of the web so as not to reach 200 degrees Celsius or higher, stretching the resulting film at a temperature of from 60 degrees Celsius to 200 degrees Celsius in a direction different form the stretching direction of the first stretching (second stretching step).

The step for reducing the residual solvent amount of the web to 10% by mass or less while controlling the surface temperature of the web so as not to reach 200 degrees Celsius or higher may be referred to as a crystallization treatment (step). “Web” means a cellulose acylate film before the drying step. According to the above-described method, a web having a residual solvent amount of from 100 to 300% is stretched in the first stretching step, and therefore, the web is broken little even when the stretching temperature is low as compared with that in dry stretching. In addition, since the stretching ratio in stretching may be increased before the crystallization treatment, the degree of crystallinity can be increased even in the crystallization treatment step after the stretching.

In the method, a web having a residual solvent amount of from 100 to 300% is stretched in the first stretching step, and therefore, the web can be stretched at a high stretching ratio. Accordingly, according to the method, the range of Re of the film to which can be adjusted may be broad. Further, the production method includes the step of drying the web at a mean surface temperature not higher than 200 degrees Celsius, and includes also the step for reducing the residual solvent amount in the web to 100% by mass or less after the beginning of the first stretching step and before the beginning of the drying step so that the residual solvent amount in the web is equal to or less than 100% by mass at the beginning of the drying step. Falling within the range, a film having the optical characteristics mentioned below can be obtained.

### <Casting Step>

According to the above-described method, in the casting step, a polymer solution containing a cellulose acylate (occasionally referred to as “dope”) is cast to form a web.

### [Cellulose Acylate]

Cellulose acylate is preferably used for the main component polymer of the cellulose acylate film. The “main component polymer” as referred to herein is meant to indicate the polymer itself when the film is formed of a single polymer, and when the film is formed of different polymers, then it indicates the polymer having the highest mass fraction of all the polymers constituting the film.

Regarding the degree of acyl substitution of the cellulose acylate to be used as the material for the cellulose acylate film, for example, a cellulose acylate having an acetyl group alone may be used, or a composition containing a cellulose acylate having a plurality of different acyl substituents may also be used. Preferably, the cellulose acylate has a total degree of substitution of from 2.7 to 3.0 for making the film have a negative intrinsic birefringence. “Negative intrinsic birefringence” means a property of a polymer film of such that, when stretched, the film has a maximum refractive index in the direction perpendicular to the stretching direction. Preferably in the invention, the film attains the necessary negative intrinsic birefringence when having the above-mentioned degree of acyl substitution and processed through the stretching or crystallization treatment step to be mentioned below.

The cellulose acylate is an ester of cellulose with an acid. The acid for the ester is preferably an organic acid, more preferably a carboxylic acid, further more preferably a fatty acid having from 2 to 22 carbon atoms, most preferably a lower fatty acid having from 2 to 4 carbon atoms. In the cellulose acylate, all or a part of the hydrogen atoms of the hydroxyl groups existing at the 2-, 3- and 6-positions of the glucose unit constituting the cellulose are substituted with an acyl group. Examples of the acyl group are acetyl, propionyl, butyryl, isobutyryl, pivaloyl, heptanoyl, hexanoyl, octanoyl, decanoyl, dodecanoyl, tridecanoyl, tetradecanoyl, hexadecanoyl, octadecanoyl, cyclohexanecarbonyl, oleoyl, benzoyl, naphthylcarbonyl and cinnamoyl. The acyl group is preferably acetyl, propionyl, butyryl, dodecanoyl, octadecanoyl, pivaloyl, oleoyl, benzoyl, naphthylcarbonyl, cinnamoyl, and most preferably acetyl, propionyl, butyryl. The cellulose ester may be an ester of cellulose with different carboxylic acids. The cellulose acylate may be substituted with different acyl groups. For the cellulose acylate film produced by the producing method of the invention, expression in Re and humidity dependency of the retardation are controlled by controlling SA and SB. The SA and SB represent a substitution degree of acetyl group (having 2 carbon atoms) which are substituted for hydroxyl group of cellulose of cellulose acylate and a substitution degree of acyl group having 3 or more carbon atoms which are substituted for hydroxyl group of cellulose, respectively. Even more, Tc is also controlled by them and the high vaporization crystallization treatment temperature is thereby controlled. The humidity dependency of the retardation is reversible retardation variation according to the humidity.

In accordance with the necessary optical properties of the film, the cellulose acylate film produced according to the production method of the invention, SA+SB is suitably controlled. Preferably 2.70<SA+SB 3.00, more preferably 2.88 SA+SB≦3.00, even more preferably 2.89≦SA+SB≦2.99, still more preferably 2.90≦SA+SB≦2.98, further more preferably 2.92≦SA+SB≦2.97. Increasing SA+SB brings about Re of the film obtained after high vaporization crystallization treatment may be increased, Tc of the film may be lowered and the humidity dependence of the retardation of the film may be improved. When Tc is set lower, the high vaporization crystallization treatment temperature may be set relatively low. By controlling SB, the humidity dependence of the retardation of the cellulose acylate film produced according to the production method of the invention may be controlled. By increasing SB, the humidity dependence of the retardation of the film may be reduced, and the melting point of the film may lower. In consideration of the balance between the humidity dependence of retardation of the film and the lowering of the glass transition temperature and the melting point thereof, the range of SB is preferably 0<SB≦3.0, more preferably 0<SB≦1.0, even more preferably SB=0. In case where all the hydroxyl groups of cellulose are substituted, the above mentioned degree of substitution is 3.

The cellulose ester is possible to be synthesized by a known method. Regarding a method for synthesizing cellulose acylate, its basic principle is described in Wood Chemistry by Nobuhiko Migita et al., pp. 180-190 (Kyoritsu Publishing, 1968). One typical method for synthesizing cellulose acylate is a liquid-phase acylation method with carboxylic acid anhydride-carboxylic acid-sulfuric acid catalyst. Concretely, a starting material for cellulose such as cotton linter or woody pulp is pretreated with a suitable amount of a carboxylic acid such as acetic acid, and then put into a previously-cooled acylation mixture for esterification to synthesize a complete cellulose acylate (in which the overall substitution degree of acyl group in the 2-, 3- and 6-positions is nearly 3.00). The acylation mixture generally includes a carboxylic acid serving as a solvent, a carboxylic acid anhydride serving as an esterifying agent, and sulfuric acid serving as a catalyst. In general, the amount of the carboxylic acid anhydride to be used in the process is stoichiometrically excessive over the overall amount of water existing in the cellulose that reacts with the carboxylic acid anhydride and that in the system. Next, after the acylation, the excessive carboxylic acid anhydride still remaining in the system is hydrolyzed, for which, water or water-containing acetic acid is added to the system. Then, for partially neutralizing the esterification catalyst, an aqueous solution that contains a neutralizing agent (e.g., carbonate, acetate, hydroxide or oxide of calcium, magnesium, iron, aluminium or zinc) may be added thereto. Then, the resulting complete cellulose acylate is saponified and ripened by keeping it at 20 to 90° C. in the presence of a small amount of an acylation catalyst (generally, sulfuric acid remaining in the system), thereby converting it into a cellulose acylate having a desired substitution degree of acyl group and a desired polymerization degree. At the time when the desired cellulose acylate is obtained, the catalyst still remaining in the system is completely neutralized with the above-mentioned neutralizing agent; or the catalyst therein is not neutralized, and the polymer solution is put into water or diluted acetic acid (or water or diluted acetic acid is put into the polymer solution) to thereby separate the cellulose acylate, and thereafter this is washed and stabilized to obtain the intended product, cellulose acylate.

Preferably, the polymerization degree of the cellulose acylate is 150 to 500 as the viscosity-average polymerization degree thereof, more preferably 200 to 400, even more preferably 220 to 350. The viscosity-average polymerization degree may be measured according to a description of limiting viscosity method by Uda et al. (Kazuo Uda, Hideo Saito; Journal of the Fiber Society of Japan, vol. 18, No. 1, pp. 105-120, 1962). The method for measuring the viscosity-average polymerization degree is described also in JP-A-9-95538.

Cellulose acylates where the amount of low-molecular components is small may have a high mean molecular weight (polymerization degree), but its viscosity may be lower than that of ordinary cellulose acylate. Such cellulose acylates where the amount of low-molecular components is small may be obtained by removing low-molecular components from cellulose acylate synthesized in an ordinary method. The removal of low-molecular components may be attained by washing cellulose acylate with a suitable organic solvent. Cellulose acylate where the amount of low-molecular components is small may be obtained by synthesizing it. In case where cellulose acylate where the amount of low-molecular components is small is synthesized, it is desirable that the amount of the sulfuric acid catalyst in acylation is controlled to be 0.5 to 25 parts by mass relative to 100 parts by mass of cellulose. When the amount of the sulfuric acid catalyst is controlled to fall within the range, then cellulose acylate having a preferable molecular weight distribution (uniform molecular weight distribution) can be synthesized. The polymerization degree and the distribution of the molecular weight of the cellulose acylate can be measured by the gel penetration chromatography (GPC), etc.

The starting material, cotton for cellulose ester and methods for synthesizing it are described also in Hatsumei Kyokai Disclosure Bulletin (No. 2001-1745, issued on Mar. 15, 2001, Hatsumei Kyokai), pp. 7-12.

The cellulose acylate to be used as the starting material in producing the cellulose acylate film may be a powdery or granular one, or may also be pelletized one. The water content of the cellulose acylate to be used as the starting material is preferably equal to or less than 1.0% by mass, more preferably equal to or less than 0.7% by mass, most preferably equal to or less than 0.5% by mass. As the case may be, the water content is preferably equal to or less than 0.2% by mass. In case where the water content of the cellulose acylate is not within the preferred range, it is desirable that the cellulose acylate is dried with dry air or by heating and then used in the invention.

In producing the cellulose acylate film, one or more different types of polymers may be used either singly or as combined.

### [Polymer Solution]

In the casting step, a web is formed of a polymer solution, containing cellulose acylate(s) and, if necessary, additive(s), according to the solution casting method. The polymer solution, which can be used in the invention, will be described in detail.

### (Solvent)

The main solvent to be used for preparing the polymer solution is preferably selected from the good organic solvents for the cellulose acylate(s). Such an organic solvent preferably has the boiling point of equal to or lower than 80 degrees Celsius in terms of reducing burden during drying. Preferably, the boiling point of the solvent is from 10 to 80 degrees Celsius, or of from 20 to 60 degrees Celsius. In some cases, the main solvent may be selected from the organic solvents having the boiling point of from 40 to 45 degrees Celsius. Among the organic solvents described later, halogenated hydrocarbons are preferable as a main solvent. Among the halogenated hydrocarbons, chlorinated hydrocarbons are preferable, and dichloromethane and chloroform are more preferable. Dichloromethane is especially preferable. In the invention, a solvent system containing a solvent having a small degree of vaporization and capable of being gradually concentrated and having a boiling point of not lower than 95 degrees Celsius along with a halogenated hydrocarbon therein in an amount of from 1 to 15% by mass, preferably from 1 to 10% by mass, more preferably from 1.5 to 8% by mass of all the solvent system may be used, in the initial stage of the drying step. The solvent having a boiling point of not lower than 95 degrees Celsius is preferably a poor solvent for cellulose acylate. Specific examples of the solvent having a boiling point of not lower than 95 degrees Celsius include those having a boiling point of not lower than 95 degrees Celsius of the solvents to be mentioned below as the specific examples of “Organic Solvent to be Combined with the Main Solvent”. Above all, preferred are butanol, pentanol and 1,4-dioxane. More preferably, the solvent for the polymer solution for use in the invention contains an alcohol in an amount of from 5 to 40% by mass, of from 10 to 30% by mass, of from 12 to 25% by mass or of from 15 to 25% by mass. In case where the “solvent having a boiling point of not lower than 95 degrees Celsius” is an alcohol such as butanol, its content may be counted as the alcohol content referred to herein. Using the solvent of the type may increase the mechanical strength of the produced cellulose acylate film at a high vaporization crystallization treatment temperature, and therefore, the film may be prevented from being stretched over the necessity during the high vaporization crystallization treatment and may be thereby prevented from being broken with ease.

The main solvent includes halogenated hydrocarbons, esters, ketones, ethers, alcohols and hydrocarbons, which may have a branched structure or a cyclic structure. The main solvent may have two or more functional groups of any of esters, ketones, ethers and alcohols (i.e., —O—, —CO—, —COO—, —OH). Further, the hydrogen atoms in the hydrocarbon part of these esters, ketones, ethers and alcohols may be substituted with a halogen atom (especially, fluorine atom). Regarding the main solvent of the polymer solution to be used in producing the cellulose acylate film produced by the method for producing it of the invention, when the solvent of the solution is a single solvent, then it is the main solvent, but when the solvent is a mixed solvent of different solvents, then the main solvent is the solvent having the highest mass fraction of all the constitutive solvents. The main solvent is preferably a halogenated hydrocarbon.

The organic solvent that may be combined with the major solvent includes halogenated hydrocarbons, esters, ketones, ethers, alcohols and hydrocarbons, which may have a branched structure or a cyclic structure. The organic solvent may have two or more functional groups of any of esters, ketones, ethers and alcohols (i.e., —O—, —CO—, —COO—, —OH). Further, the hydrogen atoms in the hydrocarbon part of these esters, ketones, ethers and alcohols may be substituted with a halogen atom (especially, fluorine atom).

Preferable examples of the halogenated hydrocarbon which can be used in the invention include chlorinated hydrocarbons such as dichloromethane and chloroform; and dichloromethane is more preferable. The ester includes, for example, methyl formate, ethyl formate, propyl formate, pentyl formate, methyl acetate, ethyl acetate and pentyl acetate. The ketone includes, for example, acetone, methyl ethyl ketone, diethyl ketone, diisobutyl ketone, cyclopentanone, cyclohexanone, and methylcyclohexanone. The ether includes, for example, diethyl ether, methyl-tert-butyl ether, diisopropyl ether, dimethoxymethane, dimethoxyethane, 1,4-dioxane, 1,3-dioxolane, 4-methyl dioxolane, tetrahydrofuran, methyl tetrahydrofuran, anisole and phenetole. The alcohol includes, for example, methanol, ethanol, 1-propanol, 2-propanol, 1-butanol, 2-butanol, tert-butanol, 1-pentanol, 2-methyl-2-butanol, cyclohexanol, 2-fluoroethanol, 2,2,2-trifluoroethanol, 2,2,3,3-tetrafluoro-1-propanol. C₁₋₄ alcohols are preferable; methanol, ethanol, and butanol are more preferable; and methanol and butanol are especially preferable. The hydrocarbon includes, for example, n-pentane, cyclohexane, n-hexane, toluene and xylene. The organic solvent having two or more different types of functional groups includes, for example, 2-ethoxyethyl acetate, 2-methoxyethanol, 2-butoxyethanol, methyl acetoacetate.

The polymer constituting the cellulose acylate film in the invention contains a hydrogen-bonding functional group such as hydroxyl group, ester, ketone and the like, and therefore, the solvent preferably contains an alcohol in an amount of from 5 to 30% by mass, more preferably from 7 to 25% by mass, even more preferably from 10 to 20% by mass of the entire solvent from the viewpoint of reducing the film peeling load from the casting support.

Controlling the alcohol content may make it easy to control the Re and Rth expression in the cellulose acylate film produced according to the production method of the invention. Concretely, when the alcohol content is increased, then the high vaporization crystallization treatment temperature may be set relatively low, and the ultimate range of Re and Rth may be increased.

In the method, adding a small amount of water to the polymer solution is also effective for controlling the solution viscosity, for increasing the wet film strength in drying, and for increasing the dope strength in casting on drum; and for example, water may be added to the solution in an amount of from 0.1 to 5% by mass of all the solution, more preferably from 0.1 to 3% by mass, even more preferably from 0.2 to 2% by mass.

Preferable examples of the combination of the organic solvents which can be used for preparing the polymer solution include, but are not limited, those described below. The numerical data of the ratio are in terms of part by mass.

(1) dichloromethane/methanol/ethanol/butanol=80/10/5/5
(2) dichloromethane/methanol/ethanol/butanol=80/5/5/10
(3) dichloromethane/isobutyl alcohol=90/10
(4) dichloromethane/acetone/methanol/propanol=80/5/5/10
(5) dichloromethane/methanol/butanol/cyclohexane=80/8/10/2
(6) dichloromethane/methyl ethyl ketone/methanol/butanol=80/10/5/5
(7) dichloromethane/butanol=90/10
(8) dichloromethane/acetone/methyl ethyl ketone/ethanol/butanol=68/10/10/7/5
(9) dichloromethane/cyclopentanone/methanol/pentanol=80/2/15/3
(10) dichloromethane/methyl acetate/ethanol/butanol=70/12/15/3
(11) dichloromethane/methyl ethyl ketone/methanol/butanol=80/5/5/10
(12) dichloromethane/methyl ethyl ketone/acetone/methanol/pentanol=50/20/15/5/10
(13) dichloromethane/1,3-dioxolan/methanol/butanol=70/15/5/10
(14) dichloromethane/dioxane/acetone/methanol/butanol=75/5/10/5/5
(15) dichloromethane/acetone/cyclopentanone/ethanol/isobutyl alcohol/cyclohexane=60/18/3/10/7/2
(16) dichloromethane/methyl ethyl ketone/acetone/isobutyl alcohol=70/10/10/10
(17) dichloromethane/acetone/ethyl acetate/butanol/hexane=69/10/10/10/1
(18) dichloromethane/methyl acetate/methanol/isobutyl alcohol=65/15/10/10
(19) dichloromethane/cyclopentanone/ethanol/butanol=85/7/3/5
(20) dichloromethane/methanol/butanol=83/15/2
(21) dichloromethane=100
(22) acetone/ethanol/butanol=80/15/5
(23) methyl acetate/acetone/methanol/butanol=75/10/10/5
(24) 1,3-dioxolan=100
(25) dichloromethane/methanol/butanol/water=85/13/1.5/0.5
(26) dichloromethane/acetone/methanol/butanol/water=87/5/5/2.5/0.5
(27) dichloromethane/methanol=92/8
(28) dichloromethane/methanol=90/10.
(29) dichloromethane/methanol=87/13
(30) dichloromethane/ethanol=90/10
(31) dichloromethane/methanol/butanol=79/20/1

The details of a case where a non-halogen organic solvent is the essential solvent are described in Hatsumei Kyokai Disclosure Bulletin (No. 2001-1745, published by the Hatsumei Kyokai on Mar. 15, 2001), and they may be suitably referred to herein.

### (Solution Concentration)

The cellulose acylate concentration in the polymer solution to be prepared herein is preferably from 5 to 40% by mass, more preferably from 10 to 30% by mass, most preferably from 15 to 30% by mass. The cellulose acylate concentration may be controlled in such a manner that it could have a predetermined concentration in the stage where cellulose acylate is dissolved in a solvent. A low-concentration solution (e.g., from 4 to 14% by mass) may be previously prepared, and it may be concentrated by evaporation of the solvent. A high-concentration solution may be prepared, and it may be diluted. When additives are added thereto, the cellulose acylate concentration of the solution may also be lowered.

### (Additives)

The cellulose acylate solution to be used for producing the cellulose acylate film of the invention may contain various liquid or solid additives added thereto in each preparation step, in accordance with the application of the film. Examples of the additives are plasticizer (its preferred amount is from 2 to 30% by mass of cellulose acylate, and the same shall apply hereinunder), agent for controlling retardation (0.01 to 10% by mass), agent for controlling the wavelength dispersion (0.1 to 20% by mass), UV absorbent (0.001 to 20% by mass), fine powder having a mean particle size of from 5 to 3000 nm (0.001 to 1% by mass), fluorine-containing surfactant (0.001 to 1% by mass), release agent (0.0001 to 1% by mass), anti-degradation agent (0.0001 to 1% by mass), and IR absorbent (0.001 to 1% by mass). And the additives are preferably selected from the materials which can change (that is, reduce) the Tc of the cellulose acylate film, having the amount of the residual solvent of equal to or less than 1%, by the temperature of from 20 to 100 degrees Celsius, when being added to the film, since crystallization in the drying may proceed at a lower temperature.

### (Preparation of Cellulose Acylate Solution)

The polymer solution may be prepared, for example, according to the methods described in JP-A 58-127737, 61-106628, 2-276830, 4-259511, 5-163301, 9-95544, 10-45950, 10-95854, 11-71463, 11-302388, 11-322946, 11-322947, 11-323017, 2000-53784, 2000-273184, 2000-273239. Concretely, a polymer and a solvent are mixed, stirred and swollen, and optionally cooled or heated to dissolve the polymer, and this is filtered to obtain the polymer solution.

The method may include cooling and/or heating the mixture of polymer and solvent for the purpose of improving the solubility of the polymer in the solvent. In case where a halogen-containing organic solvent is used as the solvent and a cellulose acylate and when the mixture of cellulose acylate and solvent is cooled, it is desirable that the mixture is cooled to −100 to 10 degrees Celsius. Also preferably, the method includes swelling the mixture at −10 to 39 degrees Celsius prior to the cooling step, and includes heating it at 0 to 39 degrees Celsius after the cooling step.

In case where a halogen-containing organic solvent is used as the solvent and the mixture of cellulose acylate and solvent is heated, it is desirable that method includes dissolving cellulose acylate in the solvent according to at least one process selected from the following (a) or (b):

(a) The mixture is swollen at −10 to 39 degrees Celsius, and the resulting mixture is heated at 0 to 39 degrees Celsius.

(b) The mixture is swollen at −10 to 39 degrees Celsius, then the resulting mixture is heated under 0.2 to 30 MPa and at 40 to 240 degrees Celsius, and the heated mixture is cooled to 0 to 39 degrees Celsius.

In case where a halogen-free organic solvent is used as the solvent and the mixture of cellulose acylate and solvent is cooled, the method preferably includes cooling the mixture to −100 to −10 degrees Celsius. Also preferably, the method includes swelling the mixture at −10 to 55 degrees Celsius prior to the cooling step, and heating it at 0 to 57 degrees Celsius after the cooling step.

In case where a halogen-containing organic solvent is used as the solvent and the mixture of cellulose acylate and solvent is heated, it is desirable that method includes dissolving cellulose acylate in the solvent according to at least one process selected from the following (c) or (d):

(c) The mixture is swollen at −10 to 55 degrees Celsius, and the resulting mixture is heated at 0 to 57 degrees Celsius.

(d) The mixture is swollen at −10 to 55 degrees Celsius, then the resulting mixture is heated under 0.2 to 30 MPa and at 40 to 240 degrees Celsius, and the heated mixture is cooled to 0 to 57 degrees Celsius.

### [Forming of Web]

The web may be produced according to a solution casting method using the above-mentioned polymer solution. The solution casting method may be attained in any ordinary manner, using an general apparatus. Concretely, a dope (polymer solution) prepared in a dissolver (tank) is filtered, and then it is once stored in a storage tank in which the dope is defoamed to be a final dope. The dope is kept warmed at 30 degrees Celsius, and fed into a pressure die from the dope take-out port, for example, via a pressure meter gear pump via which a predetermined amount of the dope may be accurately fed to the die by controlling the revolution thereof, and then the dope is then uniformly cast onto a metal support in the casting zone that runs endlessly, through the slit of the pressure die (casting step). Next, at the peeling point at which the metal support runs almost, one-round, a wet dope film (this may be referred to as a web) is peeled from the metal support, and then transported to a drying zone, in which the web is dried while transported therein by rolls. The details of the casting step and the drying step of the solution casting method are described in JP-A 2005-104148, pp. 120-146, and are suitably applicable to the invention.

As the metallic support, which can be used fro forming the web, metal bands or metal drums may be used. The polymer solution may be flow cast as a single layer solution on a smooth band or drum employed as a metallic support. Alternatively, a plurality of cellulose acylate solutions may be flow cast in two or more layers. In the case of flow casting a plurality of cellulose acylate solutions, individual solutions may be flow cast respectively from a plurality of casting ports provided on the metallic support along the running direction at certain intervals, and be laminated to obtain a film. For example, the methods described in JP-A No. 61-158414, JP-A No. 1-122419 and JP-A No. 11-198285 may be applied.

Alternatively, the polymer solution may be cast from two casting ports to form a film, and for example, the methods described in JP-B No. 60-27562, JP-A No. 61-94724, JP-A No. 61-947245, JP-A No. 61-104813, JP-A No. 61-158413 and JP-A No. 6-134933 may be used. It is also possible to adopt the cellulose acylate film solution casting method reported in JP-A No. 56-162617, which comprises wrapping a high-viscosity polymer solution flow with a low-viscosity polymer solution and simultaneously extruding both of these high-viscosity and low-viscosity polymer solutions. Moreover, it is also a preferred embodiment to employ the methods of JP-A No. 61-94724 and JP-A No. 61-94725 in which the outer solution contains an alcoholic solvent, which is a poor solvent, in a larger amount than the inner solution. It is also possible to employ the method of, for example, JP-B No. 44-20235, which comprises using two casting ports, peeling a film that has been formed on a metallic support through the first casting port, and then effecting the second flow casting on the side which is in contact with the metallic support face, to construct a multilayered film. The polymer solutions to be cast may be the same or different, without particular limitation. To impart functions to a plurality, other solutions corresponding to the respective functions may be extruded from the respective ports. It is also possible to cast the polymer solution simultaneously with other functional layers (for example, an adhesive layer, a dye layer, an antistatic layer, an anti-halation layer, an ultraviolet absorbing layer, a polarizing layer, etc.).

To achieve a desired film thickness by using a conventional single layer solution, it is necessary to extrude the polymer solution having a high concentration and a high viscosity. In this case, the poor stability of the polymer solution frequently causes problems such as machine troubles due to the formation of solid matters and surface irregularities. These problems can be overcome by casting a plurality of polymer solutions through a plurality of casting ports in relatively small amounts. Thus, highly viscous solutions can be simultaneously extruded on a metallic support, and thus an excellent film having improved surface smoothness can be obtained. In addition, use of thick polymer solutions contributes to the reduction in the drying load, and the resulting film in turn can be produced at an elevated production speed.

In the case of co-casting, the inner thickness and the outer thickness are not particularly limited, but it is preferable that the outer thicknesses 1 to 50%, and more preferably 2 to 30%, of the total film thickness. In the case of simultaneous casting of three or more layers, the total film thickness of the layer which is in contact with the metallic support and the layer which is in contact with the atmosphere is defined as the outer thickness. In the co-casting, it is also, possible to co-cast polymer solutions differing from each other in the concentrations of additives such as a plasticizer, an ultraviolet absorbent, a matting agent, and the like as described above, thus to form a cellulose acylate film of a laminated structure. For example, a cellulose acylate film composed of a skin layer/a core layer/a skin layer can be formed thereby. For example, a matting agent can be added in a larger amount to the skin layers or exclusively to the skin layers. A plasticizer and an ultraviolet absorbent may be added in larger amounts to the core layer than to the skin layer or exclusively to the core layer. It is also possible to use different types of plasticizers or ultraviolet absorbents to the core layer and the skin layers. For example, at least any of a less volatile plasticizer and ultraviolet absorbent may be added to the skin layers, while a plasticizer having an excellent plasticizing effect or an; ultraviolet absorbing agent showing favorable ultraviolet absorption properties may be added to the core layer. It is also a preferred embodiment to add a peeling accelerator exclusively to the skin layer in the metallic support side. Since the solution is gelled by cooling the metallic support by the cooling drum method, it is also preferred to add an alcohol, which is a poor solvent, in a larger amount to the skin layers. The skin layers and the core layer, may have different Tgs. It is preferable that the Tg of the core layer is lower than the Tg of the skin layer. Also, the skin layers and the core layer may show different viscosities of the cellulose acylate solutions of the flow casting step. If is preferable that the viscosity of the skin layers is lower than the viscosity of the core layer, but the viscosity of the core layer may be lower than the viscosity of the skin layers.

### <First Stretching Step>

In the cellulose acylate film production method, the web formed in the previous casting step is, while conveyed, stretched in one direction at a temperature of from −30 degrees Celsius to 30 degrees Celsius while the residual solvent amount therein is kept falling between 100 and 300% by mass. Preferably, the web is stretched in the machine direction in the first stretching step from the viewpoint of the Re expressibility of the resulting film. In this stage, the residual solvent amount in the wet at the start of the first stretching is from 100 to 300% by mass. The preferred temperature range in the first stretching step is from −30 degrees Celsius to 30 degrees Celsius, more preferably from −10 degrees Celsius to 0 degree Celsius.

### [Residual Solvent Amount]

The residual solvent amount of the cellulose acylate web at the beginning of the first stretching may be represented by the following formula. The residual solvent amount of the cellulose acylate web after the drying step or at the beginning of the second stretching step may also be represented by the following formula:

Residual Solvent Amount (% by mass)={(M−N)/N}×100

[in the formula, M means the mass of the cellulose acylate film just before inserted into the stretching zone; and N means the mass of the cellulose acylate film just before inserted into the stretching zone, dried at 120° C. for 2 hours].

In the first stretching step in the invention, the residual solvent amount in the web at the start of the first stretching is from 100 to 300% by mass, but is preferably from 200 to 300% by mass in consideration of the balance in peeling, the web condition, the stretching temperature, the stretching ratio in stretching, etc. In case where the residual solvent amount in the web at the start of the first stretching is less than 100% by mass, then the web being stretched may be broken at a low stretching temperature. Accordingly, the stretching temperature must be high and the energy efficiency may lower. Even when the stretching temperature is elevated, the web being stretched at a high stretching ratio may also be broken. Further, when the residual solvent amount is less than 100% by mass, the film may be hard and may be hardly stretched, and therefore the stretched film could not have the desired optical properties. On the other hand, when the residual solvent amount is more than 300% by mass, then the web peelability may worsen, the web stretching aptitude may worsen (as the web is often wrinkled and is difficult to handle), and the web recovery performance may greatly worsen. In particular, when the residual solvent amount is from 200 to 300% by mass, the stretching ratio may be increased with ease and the web may be more effectively prevented from cut or broken.

The residual solvent amount in the cellulose acylate wave at the start of the first stretching step may be suitably controlled by controlling the concentration of the polymer solution, and controlling the temperature and the speed of the metal support in the invention. Before the start of the first stretching step, the web may be dried; however, the drying before the start of the first stretching step must be at a temperature at which the web is not crystallized. Concretely, the web may be dried at a temperature not higher than 30 degrees Celsius.

During the first stretching step, the residual solvent amount in the cellulose acylate web gradually decreases, and at the end of the first stretching step, preferably, the residual solvent amount is lowered to the level at the start of the next drying step. For example, in the first stretching step, the residual solvent amount may be controlled in such a preferred manner through spontaneous drying of the web being stretched, or by introduction of dry air to the web being stretched, whereby the web may be dried at the same time of stretching it.

In the first stretching step in the invention, the web is stretched in the machine direction while conveyed. In this stage, the stretching ratio of the web is preferably from 5 to 100%, more preferably from 15 to 50% from the viewpoint of attaining the high stretching ratio in stretching and preventing the web from being broken. The stretching ratio (elongation) of the cellulose acylate web in stretching may be attained by the peripheral speed difference between the metal support speed and the peeling speed (peeling roll stretching). For example, in case where an apparatus having two nip rolls is used, the rotation speed of the nip roll on the outlet port side is made higher than the rotation speed of the nip roll on the inlet port side, whereby the cellulose acylate web can be preferably stretched in the traveling direction (machine direction). According to the stretching mode, the retardation expressibility of the resulting film can be controlled. The “stretching ratio (%)” as referred to herein can be computed according to the following formula; however, this is not limited to the method of directly measuring the length, but any other method capable of producing the same result as the stretching ratio to be computed according to the formula mentioned below may be employed for it.

Stretching Ratio (%)=100×{(length after stretching)−(length before stretching)}/(length before stretching).

In the first stretching step in the invention, the surface temperature of the web being stretched (stretching temperature) is controlled to be from −30° C. to 30° C. from the viewpoint of securing the stretching efficiency and reducing the residual solvent amount fluctuation. The web temperature control may be attained by controlling the metal support temperature and the zone temperature. Not specifically defined, the stretching speed in the stretching step is preferably from 1 to 1000%/min, more preferably from 1 to 100%/min, from the viewpoint of the stretching aptitude (no wrinkling, good handlability). The web may be stretched in one stage or in multiple stages.

After the first stretching step, the web is then conveyed to the next drying (crystallization treatment) step.

### <Drying (Crystallization Treatment) Step>

After the stretching treatment, the web is then treated in the next drying step for reducing the residual solvent amount thereof by the amount of equal to or less than 100% by mass while controlling the surface temperature of the web so as not to reach 200° C. or higher (crystallization treatment). Under the condition satisfying the above-mentioned requirements, the molecular movement inside the cast web is sufficient even at such a low temperature, and in addition, the number of the molecules detracting from the crystallization is sufficiently small under the crystallization condition, and therefore, the crystallization efficiently goes on at a low temperature. In case where the web surface temperature is lower than the above, the molecular movement could not be sufficient; but when higher, the molecular movement may be too great and the crystallization could not proceed.

After the first stretching step, the residual solvent amount in the web is preferably reduced by 10% or less while the web surface temperature is more preferably controlled to be from 30 to 100 degrees Celsius, even more preferably from 50 to 100 degrees Celsius in the drying step, from the viewpoint of the optical expressibility of the resulting film. At the start of the drying step, the residual solvent amount is preferably equal to or less than 100%, preferably from 10 to 100% by mass, more preferably from 20 to 100% by mass. When the residual solvent amount is equal to or less than 100% by mass, the molecular movement may be sufficient and the number of the molecules that inhibit the crystallization may increase, and therefore the crystallization may be easy. When the residual solvent amount is equal to or more than 10% by mass, the molecular movement may be satisfactory at a low temperature.

A step of reducing the residual solvent amount to at most 100% by mass from the start of the first stretching step to the start of the drying step may be carried out simultaneously with the stretching in the previous first stretching step. In case where the residual solvent amount is not controlled to fall within the preferred range at the end of the first stretching step and before the start of the drying step, an additional step of reducing the residual solvent amount is carried out after the end of the first stretching step and before the start of the drying step. The step of reducing the residual solvent amount may be carried out in the same manner as the drying step before the start of the first stretching step mentioned above. Concretely, the web may be dried at a drying temperature not higher than 30 degrees Celsius.

As another step of reducing the residual solvent amount, concretely mentioned is, for example, the following embodiment, to which, however, the invention should not be limited. In a tenter, for preventing the web itself from foaming or preventing it from adhering to a holding unit, it is desirable that the pins of holding both sides of the web are cooled to a temperature lower than the web foaming temperature by an air-blowing cooler in the tenter drier and the pins just before the site where the web begins to be held by them are cooled to 0 degree Celsius or lower by the dope in the duct-type cooler.

Preferably, the drying (crystallization) treatment in the production method of the invention is attained while the cellulose acylate film is conveyed. The method of conveying the cellulose acylate film is not specifically defined, and the web is held in its both edge by tenter clips or pin tenter and dried in the drying (crystallization) treatment. Typical embodiments include a method of conveying the film by nip rolls or suction drums; a method of conveying the film while held by tenter clips, and a method of flowing and conveying the film by pneumatic pressure. Preferred is the method of conveying the film while held in its both edge by a pin tenter or the method of conveying the film by the plural conveyor rollers spaced narrowly from each other, and more preferred is the method of conveying the film while held in its both edge by a pin tenter.

The method of conveying the web while fixed with a pin tenter is concretely effected by fixing the two edges of the cellulose acylate web on the line perpendicular to the machine direction with a pin tenter, and conveying the web while controlling the distance between the tenter by which one side is fixed and the tenter by which the other side is fixed. The tenter-to-tenter distance may be controlled by suitably defining the tenter rail pattern. By controlling the distance between the tenters in the manner as above, the cellulose acylate web can be dried while controlling the dimensional change in the cross direction to a desired level. For preventing the web from being cut or broken or wrinkled and for preventing the conveyance failure, preferably, the inside pin density is large and the outside pin density is small in the pin tenter.

The method of conveying the web by plural conveyor rollers spaced narrowly from each other is concretely effected by leading a cellulose acylate web to pass through the space between plural conveyor rollers installed inside a crystallization treatment zone in such a manner that the adjacent conveyor rollers are spaced from each other by a distance of from 0.1 cm to 50 cm. The distance between the adjacent conveyor rollers is meant to indicate the distance in which the traveling web runs from leaving from one conveyor roll to reaching the next conveyor roll. By leading the web to pass through such a group of conveyor rolls that are spaced narrowly from each other (so-called dense rolls), the retention power of the conveyor rolls acts on the cross direction of the web to thereby reduce the dimensional change in the cross direction of the web. According to the method, the web could not be expanded in the cross direction like in a tenter clip method is impossible, but the shrinkage of the web could be minimized.

The film-traveling speed in the drying (crystallization) treatment is generally from 1 to 500 m/min, preferably from 5 to 300 m/min, more preferably from 10 to 200 m/min, even more preferably from 20 to 100 m/min. When the film-traveling speed is at least the above-mentioned lowermost limit, 1 m/min, then the method is favorable as capable of securing a sufficient industrial producibility; and when it is at most the above-mentioned highest limit of 500 m/min, then the method is also favorable for the capability of good crystal growth promotion within a crystallization treatment zone length. When the film-traveling speed is higher, then the film coloration may be prevented more; and when it is lower, the crystallization treatment zone length may be shorter. Preferably, the film-traveling speed during heat treatment (the device speed of the nip rolls and the suction drum that determines the film-traveling speed) is kept constant.

The drying (crystallization) treatment in the production method of the invention includes, for example, a method of leading a cellulose acylate film to run in a zone having a temperature T while transported through it; a method of applying hot air to a cellulose acylate film being transported; a method of irradiating a cellulose acylate film being transported with heat rays; and a method of contacting a cellulose acylate film with a heated roll. Preferred is the method of leading a cellulose acylate film to run in a zone having a temperature T, to which a hot air is sent, while transported through it. According to the method, a cellulose acylate film may be heated uniformly, which is an advantage. The temperature inside the zone may be controlled and kept constant at T by a heater while monitoring with, for example, a temperature sensor. The traveling length of the cellulose acylate film running in the zone at a temperature T may vary depending on the property of the cellulose acylate film to be produced and on the film-traveling speed; but in general, it is preferably so set that the ratio of (traveling length)/(width of the traveling cellulose acylate film) could be from 0.1 to 100, more preferably from 0.5 to 50, even more preferably from 1 to 20. In this description, the ratio may be referred to as an aspect ratio. The film-running time in the zone at a temperature T (crystallization treatment time) may be generally from 0.01 to 60 minutes, preferably from 0.03 to 10 minutes, more preferably from 0.05 to 5 minutes. Within the range, the retardation expressibility may be excellent and the processed film may be prevented from being colored.

For preventing the reduction in the quality such as the surface smoothness of the film by increasing the speed in solution casting or by expanding the width of the web by the use of a tenter, it is desirable that, when the web is dried in a tenter in the drying step, the air velocity is from 0.5 to 20 (40) m/sec, the temperature distribution in the cross direction is at most 10% and the blast ratio between the above and the below of the web is from 0.2 to 1. The air velocity distribution on the web surface positioned in the extended direction from the drying gas blast direction is, when based on the uppermost limit of the air speed, preferably such that the difference between the uppermost limit and the lowermost limit is within 20%, and under the condition, dry gas is belched out to dry the web.

In the production method, the drying (crystallization treatment) step may be carried out once or plural times. “Effecting the step plural times” means that after the previous drying (crystallization treatment) step, the web is again heated up to a temperature lower than 200° C. but higher than the temperature at the end of the previous heating (crystallization treatment step), and while conveyed, it is again processed for crystallization treatment. In case where the web is processed plural times for crystallization treatment, it is desirable that the stretching ratio satisfies the above-mentioned range after the stage of all the crystallization treatment steps. Preferably in the production method, the crystallization treatment is carried out at most three times, more preferably at most two times, and most preferably, it is carried out once.

### [Second Stretching Step]

According to the method, after the first stretching treatment, the residual solvent amount in the web is reduced by the amount of equal to or less than 100% by mass while controlling the surface temperature thereof so as not to reach 200 degrees Celsius or higher; and then, the film is stretched at a temperature of from 60 degrees Celsius to 200 degrees Celsius in the direction different from that in the previous first stretching step is carried out (a second stretching step). The stretching temperature in the second stretching step is from 60 to 200° C., preferably from 90 to 140° C. When the stretching temperature is 60° C. or higher, then the film can be stretched sufficiently, and when it is not higher than 200° C., the problem of additive bleeding or evaporation is noticeably evaded.

It is considered that, by carrying out the second stretching under the condition as above, the oriented amorphous part may be reduced not significantly moving the crystal part. Accordingly, not significantly changing Re, the humidity dependence of Re can be reduced. In addition, the wavelength dispersion characteristics of the film can be controlled. In the second stretching step, preferably, the film is stretched in the direction different from the machine direction, or that is, in the direction perpendicular to the machine direction from the viewpoint of efficiently reducing the oriented amorphous part.

Also preferably, the film is stretched in TD (transverse direction, or that is, the direction perpendicular to the machine direction, or the film traveling direction), from the viewpoint of effectively reducing the humidity dependence of the retardation (especially Re) of the transparent film to be finally obtained. The reduction in the humidity dependence reduces the humidity change-dependent display fluctuation and therefore enhances the display stability.

By carrying out the second stretching step that satisfies the above-mentioned condition after the drying step, the humidity dependence of the obtained film may be reduced and the wavelength dispersion characteristics thereof can be controlled. The humidity dependence and the wavelength dispersion characteristics of the film are governed mainly by the orientation of the amorphous part and the additive (agent for controlling wavelength dispersion). On the other hand, the direction of the slow axis of the film and the absolute values of Re and Rth thereof are governed mainly by the orientation of the crystal part. The orientation direction of the film before stretching is investigated. In the film processed for crystallization treatment alone, the crystal part, the amorphous part and the additive are oriented in the machine direction in the crystallization treatment step. The invention is characterized in that, after the drying (crystallization treatment) step, the film is processed in the second stretching step within the above-mentioned specific range. The invention is based on the characteristic finding that, in the stretching after the drying step, the speed of changing the orientation of the amorphous part and the additive is higher than the speed of changing the orientation of the crystal part. Specifically, by the stretching, the orientation of the amorphous part and others can be dominantly changed not significantly moving the crystal part. According to the production method of the invention, by the stretching after the drying (crystallization treatment) step, the orientation of the amorphous part and the additive can be made to be perpendicular to the orientation of the crystal part, and not changing the direction of the slow axis, the humidity dependence and the wavelength dispersion characteristics of the film can be freely controlled.

In case where the second stretching step is for TD stretching, as the method of TD stretching, for example, employable is a method comprising fixing both sides of the cellulose acylate film with a pin tenter, and leading it to pass through a heating zone while it is stretched or contracted in the direction (transverse direction) perpendicular to the machine direction. The TD stretching may be carried out in one stage or in multiple stages. Preferred is a method of holding both sides of the polymer film with a pin tenter and expanding the film in the direction perpendicular to the machine direction to thereby stretch the film.

The stretching ratio in the second stretching step may be suitably determined in accordance with the necessary retardation of the cellulose acylate film, and is preferably less than 35%, more preferably from 1% to less than 35%, even more preferably from 1 to 30%, still more preferably from 1 to 5%. The stretching speed in the TD stretching is preferably from 1 to 1000%/min, more preferably from 10 to 500%/min, even more preferably from 10 to 200%/min. After the drying (crystallization treatment) step, Re and Rth of the cellulose acylate film before the second stretching step are not specifically defined.

### (Post-Drying, Handling)

In the cellulose acylate film production method of the invention, the drying temperature in the drying step after the end of the second stretching step is preferably from 40 to 180° C., more preferably from 70 to 150° C. For further removing the residual solvent, the film is dried at 50 to 150° C., and in such a case, preferably, the film is dried with high-temperature air of which the temperature is gradually changed to thereby evaporate away the residual solvent. The method is described in JP-B 5-17844. Depending on the solvent used, the drying temperature, the drying blast amount and the drying time may vary, and may be suitably selected in accordance with the type of the solvent used and the combination of the conditions. The residual solvent amount in the final film is preferably at most 2% by mass, more preferably at most 0.4% by mass for good dimensional stability of the film.

Regarding the residual solvent amount in the dried film, JP-A 2002-241511 describes as follows: Even in a thin film having a thickness of from 20 to 60 μm, the residual solvent amount in winding it is preferably at most 0.05% by mass for the purpose of preventing the film from deforming with time, making the film optically isotropic, making the film resistant to scratching and making the film contain neither bubbles nor insoluble matter. Also preferably, the difference between the maximum value and the minimum value of the residual solvent amount in the cross direction of the film is at most 0.02% by mass, and the residual solvent amount in the film is preferably at most 0.04% by mass, more preferably at most 0.02% by mass; and for this, preferably, the drying temperature is from 100 to 150 degrees Celsius and the drying time is from 5 to 30 minutes. Within a range with no problem of additive bleeding and evaporation, the film may be further processed at a temperature of around 200° C. or so for further increasing the degree of crystallinity thereof, after the second stretching step.

For stable transportation, for bettering surface condition, for securing necessary optical characteristics and for reducing thermal shrinkage, JP-A 2003-053751 describes an invention in which, when the residual solvent amount (based on the dry amount) in the base in dry is from 3 to 7% by mass, the proportion of the poor solvent in the residual solvent amount is from 0.01 to 95% by mass.

JP-A 2003-071863 for an invention of obtaining a non-fogging film says that, in the film drying step, the film peeled from the belt is preferably further dried so that the residual solvent amount is reduced to at most 0.5% by mass, more preferably at most 0.1% by mass, most preferably from 0 to 0.01% by mass.

JP-A 5-278051 describes an invention of a solution casting method for film formation, in which, for the purpose of producing a film having physical properties of little difference in solute between the surface and the back thereof with good producibility, the solute is so selected that the interaction parameter χ between the solute and the polymer could be at most 0.9 and the film is dried until the ratio by weight of the polymer to the solvent in the cast film could be at most 23% while the ratio by weight of the polymer to the solvent in the film surface is kept to be at least 12%.

The above-mentioned inventions are all applicable to the present invention.

The process from casting to post-drying may be effected in an air atmosphere or in an inert gas atmosphere such as nitrogen gas. For drying, far-infrared rays may be used, or as in JP-A 8-134336, 8-259706 and 8-325388, microwaves may be used for drying.

JP-A 2002-283370 describes a technique of removing dust adhering to the web by disposing a film-cleaning device before introduction and/or after taking out of the film from the drying device or the thermal curing device. As the cleaning measures, the patent publication discloses various systems of flame treatment (corona treatment, plasma treatment) of systems of disposing adhesive rolls, as the method except vibration, high-pressure blasting or suction. As a preferred embodiment for preventing further contamination of the films with other impurities, the patent publication discloses installation of a discharger in a position at which the film is wound around an original wiring core, in which the discharger is so designed that the charged potential of the film once unwound from the original winding roll could be given a reversed potential of <±2 KV by a discharging device or a forced charging device in rewinding, and the forced charging potential could be discharged by the discharger for alternative positive/negative conversion of from 1 to 150 Hz, and an ionizer or a discharge bar capable of generating ionic air is utilized.

### [Thickness Unevenness]

It is important to prevent the thickness unevenness in the above described method since the degree of crystallization may be varied depending on the thickness. In particular, preferably, the thickness of the cellulose acylate film at any points is not different from the averaged thickness by more than 3 micro meters, more preferably by more than 1 micro meter. The thickness unevenness may often occur in the stretching step(s) or the casting step; and therefore, improvement of accuracy in the casting step or controlling the stretching speed in the stretching steps(s) may be important for reducing the thickness.

According to the above-described method, the cellulose acylate films having a slow axis perpendicular to the casting direction (MD direction) can be obtained.

### <Method of Producing Retardation Film>

Next, preferable examples of the method for producing the retardation film of the invention continuously are described below.

### Production Method for Rolled Retardation Film>>

The rolled retardation film may be produced according to a continuous process of the following steps (1) to (4). All of the steps may be carried out by using continued equipment throughout.

Step (1): A transparent support is prepared.

Step (2): An alignment layer is formed on the surface of the transparent support film while the transparent film is conveyed in the long direction thereof.

Step (3): The surface of the alignment layer is subjected to a rubbing treatment, and subsequently, a coating liquid containing at least one liquid crystal compound is applied to the rubbed surface of the alignment layer.

Step (4): The coating liquid applied to the surface is dried; at the same time or after the drying, molecules of the liquid-crystal compound are aligned at a temperature not lower than the liquid-crystal transition temperature; the alignment is fixed to form an optically-anisotropic layer; and the lamination is wound up.

Regarding the details of the conditions in the steps of the production method and the devices usable therein, referred to are the conditions and the devices described in JPA No. hei 9-73081.

### (Polarizing Plate)

The present invention relates to a polarizing plate comprising a retardation film of the invention and a polarizer. When the polarizing plate is incorporated into a liquid crystal display device, preferably, the polarizing plate is disposed in the device so that the optically anisotropic layer of the retardation film of the invention is on the side of the liquid crystal cell in the device. Also preferably, the surface of the retardation film of the invention is bonded to the surface of the polarizing film; and preferably, the rubbing direction of the alignment layer of the retardation film crosses the transmission axis of the polarizing film at an angle of 90 degrees. The crossing angle may not always be 90 degrees strictly, and an error of ±5 degrees acceptable in production does not have any influence on the effect of the invention, and is therefore acceptable in the invention. Also preferably, a protective film such as a cellulose acylate film is bonded to the other surface of the polarizing film.

### <Polarizer>

Examples of a polarizing film (polarizer) include an iodine-base polarizing film, a dye-base polarizing film with a dichroic dye, and a polyene-base polarizing film, and any of these is usable in the invention. The iodine-base polarizing film and the dye-base polarizing film are produced generally by the use of polyvinyl alcohol films.

### <Protective Film>

As the protective film to be bonded to the other surface of the polarizing film, preferably used is a transparent polymer film. “Transparent” means that the film has a light transmittance of at least 80%. As the protective film, preferred are cellulose acylate films, polyolefin films containing polyolefin(s) and acryl-base polymer film. Of cellulose acylate films, preferred are cellulose triacetate film. Of polyolefin films, preferred are cyclic polyolefin-containing polynorbornene films. The thickness of the protective film is preferably from 20 to 500 micro meters, or from 40 to 100 micro meters.

### <Method for Producing Polarizer>

The polarizer may be prepared as follows. A binder film is stretched in the long direction (MD direction), and then stained with iodine or dichroic dye. In the stretching method, the stretching ratio is preferably from 2.5- to 30.0-fold, or from 3.0- to 10.0-fold. Stretching the film in the air may be carried out, that is, dry-stretching may be carried out. Or stretching the film in the water may be carried out, that is, wet-stretching may be carried out. Stretching may be carried out through plural steps. By stretching the film through plural steps, it is possible to stretch the film more uniformly, compared with by stretching the film with a high stretching ratio through one step. Before being stretched, the film may be slightly stretched in the long or transverse direction for preventing shrinkage of the film in the transverse direction. The stretching may be carried out by applying a tenter-stretching on the left and right sides of the film differently in a biaxially-stretching treatment. The biaxially stretching treatment may be carried out in the same manner as the general stretching treatment to be applied to films.

### (TN Liquid Crystal Display Device)

The retardation film of the invention may be used as a retardation film of a TN mode liquid crystal display having a TN mode liquid crystal cell. ATN mode liquid crystal cell and a TN type liquid crystal display have been well known from a long time ago. As for an optical compensation sheet for use in a TN type liquid crystal display, there are descriptions in JP-A-3-9325, JP-A-6-148429, JP-A-8-50206 and JP-A-9-26572. The value of Δn.d of a TN mode liquid crystal cell is usually from about 300 to about 500 nm. In addition, descriptions exist in an articles by Mori et al. (Japanese Journal of Applied Physics Vol. 36 (1997) P. 143, Japanese Journal of Applied Physics Vol. 36 (1997) p. 1068).

The TN-mode liquid crystal cell which can be used in the invention comprises a pair of substrates disposing face to face, at least one of them having an electrode thereon; a liquid crystal layer disposed between the pair of substrates; and at least three pixels, in which a color filter is disposed, having a different main transparent wavelength from each other. At least three pixels preferably contains R, G and B pixels. According to the invention, for reducing the yellowish coloration generated in the horizontal direction, it is preferable that the thickness of the liquid crystal layer is different between at least two pixels. The preferable range of the thickness of the liquid crystal layer corresponding to each of the pixels may vary depending on And of the layer, wavelength dispersion characteristic of the liquid crystal, or transmittance of the color filter, and preferably, the relation, (the thickness of the liquid crystal layer in B pixel)≦(the thickness of the liquid crystal layer in G pixel)≦(the thickness of the liquid crystal layer in R pixel), is satisfied. And the value of d_{B}/d_{R}, where “d_{B}” represents the thickness of the liquid crystal layer in B pixel, and “d_{R}” represents the thickness of the liquid crystal layer in R pixel, is preferably equal to or less than 0.95, equal to or less than 0.9, or equal to or less than 0.8. The means for adjusting the thickness of the liquid crystal layer is not limited, and one example of the means is varying the thickness of the color filter among the pixels, so that the thickness of the liquid crystal layer varies among the domains corresponding to each of the pixels. The ratio of Δnd of the liquid crystal layer in B pixel to And of the liquid crystal layer in R pixel, that is, Δnd_{B}(wavelength 450 nm)/Δnd_{R}(wavelength 630 nm), is preferably equal to or less than 1.05, equal to or less than 1.0, or equal to or less than 0.9.

### EXAMPLES

The present invention will be explained to further detail, referring to Examples. Note that the materials, reagents, amounts and ratios of substances, operations and so forth explained in Examples below may appropriately be modified without departing from the spirit of the present invention. The scope of the present invention is, therefore, not limited to the specific examples described below.

### <<Measurement Methods>>

Evaluation methods for the properties used in the following Examples, Referential Examples and Comparative Examples, are described below.

### (1) Degree of Substitution

The degree of acyl substitution of the cellulose acylate film is determined by ¹³C-NMR according to the method described in Carbohydr. Res., 273 (1995), 83-91 (Tezuka, et al).

### (2) Quantity of Crystallization Heat (ΔHc)

A differential scanning calorimeter (DSC, “DSC8230”, produced by Rigaku Corporation) is used and 5 or 6 mg of the cellulose acylate film is put into a sample pan made of aluminum for DSC, this is heated from 25 degrees Celsius up to 120 degrees Celsius at a rate of 20 degrees Celsius/min in a nitrogen stream atmosphere at a rate of 50 ml/min, then kept as such for 15 minutes, and thereafter cooled down to 30 degrees Celsius at a rate of −20 degrees Celsius/min, and further, this is again heated from 30 degrees Celsius up to 320 degrees Celsius at a rate of 20 degrees Celsius/min, and the area surrounded by the exothermic peak appearing in the heat cycle and the base line of the sample is measured. This is the quantity of crystallization heat of the cellulose acylate film.

### Example 1

### (1) Production of Cellulose Acylate Film

### (1-1) Preparation of Dope and Casting

A polymer solution A having the formulation mentioned below was heated at 30 degrees Celsius, and then cast onto a mirror-face stainless support of a drum having a diameter of 3 m, through a caster, Giesser. The surface temperature of the support was set at −5 degrees Celsius, and the coating width was 200 cm. The space temperature in the entire casting zone was set at 15 degrees Celsius.

Formulation of Polymer Solution A

| | |
|---|---|
| Cellulose acetate having a degree of acetification of 60.9% | 100.0 mas. pts. |
| Triphenyl phosphate (plasticizer) | 7.8 mas. pts. |
| Biphenyl diphenyl phosphate (plasticizer) | 3.9 mas. pts. |
| Methyl chloride (first solvent) | 293.0 mas. pts. |
| Methanol (second solvent) | 71.0 mas. pts. |
| 1-butanol (third solvent) | 1.5 mas. pts. |
| Silica particles (AEROSIL R972, by Nippon Aerosil) | 0.8 mas. pts. |
| Retardation enhancer shown below | 1.7 mas. pts. |

Retardation enhancer

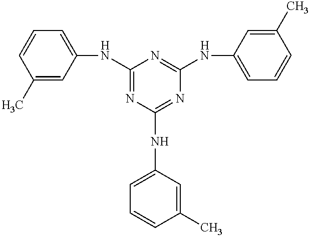

### (1-2) First Stretching Step:

At 50 cm before the end point of the casting zone, the cellulose acylate film (web) thus cast and rotated was peeled off from the drum while having a residual solvent amount of 270%, conveyed by a pin tenter and stretched by 20% in the machine direction. The stretching ratio (%) in stretching the web in the first stretching step was derived from the ratio of the drum speed to the tenter speed. The stretching temperature (web surface temperature) was kept at −5 degrees Celsius by controlling the drum temperature with a coolant. The stretching speed was 1000%/min.

### (1-3) Drying Step, Second Stretching Step:

Next, the sample was dried in the drying (crystallization treatment) step at a drying temperature (web surface temperature) of 80 degrees Celsius; and when the residual solvent amount therein reached 7%, the sample was then conveyed by a pin-tenter for the second stretching step. The drying temperature was controlled by controlling the temperature in the stretching zone with dry air. After that, the residual solvent amount in the resulting film before the start of the second stretching step was determined by sampling a part of the film in the drying zone and computing the mass change before and after drying at 120 degrees Celsius for 2 hours according to the above-mentioned method, and this is shown in Table 2 below. Next, using a pin-tenter, the film was stretched at 135 degrees Celsius by 4% in the direction perpendicular to the machine direction. The stretching temperature (film surface temperature) controlled by applying dry air to the film being stretched. The stretching speed was 60%/min. The stretching ratio (%) in the second stretching step was computed from the change in the pin tenter width at the start of the second stretching step and after the stretching.

### (1-4) Post-Drying Step, Winding:

The film after the second stretching step was dried at 140 degrees Celsius for 20 minutes. In that manner, a cellulose acylate film having a width of 1400 mm and a thickness of 73.8 μm was produced, and wound up by a winder. Thus obtained, the cellulose acylate film had Re=20 nm, and Rth=100 nm. The thickness of the film in this state was not different from the averaged thickness of the film by more than 2 micro meters at any positions thereof.

### (2) Formation of Optically Anisotropic Layer of Liquid Crystal Composition

### (2-1) Saponification of Cellulose Acylate Film:

The cellulose acylate film obtained in the above was led to pass through a dielectric heating roll at a temperature of 60 degrees Celsius so that the film surface temperature was elevated up to 40 degrees Celsius, and then, using a bar coater, an alkali solution having the formulation mentioned below was applied to it in an amount of 14 ml/m²; thereafter this was kept staying below a steam-type far-infrared heater (by Noritake Company) heated at 110 degrees Celsius for 10 seconds, and then also using a bar coater, pure water was applied thereto in an amount of 3 ml/m². In this stage, the film temperature was 40 degrees Celsius. Next, this was washed with water using a fountain coater and treated with an air knife for water removal, repeatedly three times each, and then dried in a drying zone at 70 degrees Celsius for 2 seconds.

Formulation of Alkali Solution for Saponification

| | |
|---|---|
| Potassium hydroxide | 4.7 mas. pts. |
| Water | 15.7 mas. pts. |
| Isopropanol | 64.8 mas. pts. |
| Propylene glycol | 14.9 mas. pts. |
| Surfactant (C₁₆H₃₃O(CH₂CH₂0)₁₀H) | 1.0 mas. pts. |

### (2-2) Formation of Alignment Film

On the cellulose acylate film, a coating liquid for alignment film having the formulation mentioned below was applied in an amount of 24 mL/m², using a wire bar coater of #14. This was dried with hot air at 100 degrees Celsius for 120 seconds. The thickness of the alignment film was 1.2 micro meters. Next, with the machine direction (MD direction) of the cellulose acylate film regarded as 0 degree, the coated alignment film formed on it was rubbed with rubbing roller of 2000 mm width at a rate of 400 rounds per minutes in the direction of 0 degree. The conveying speed was 40 m/min. Then, the rubbed surface was subjected to ultrasonic dust removing.

Formulation of Coating Liquid for Alignment Film

| | |
|---|---|
| Modified polyvinyl alcohol mentioned below | 40 mas. pts. |
| Water | 700 mas. pts. |
| Methanol | 300 mas. pts. |
| Triethyl amine | 20 mas. pts. |

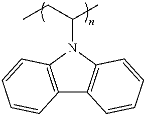

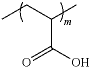

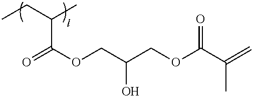

n = 40
m = 50
l = 10

### (2-3) Formation of the Optically Anisotropic Layer

A coating liquid for the optically anisotropic layer having the formulation mentioned below was continuously applied onto the rubbed surface of the alignment film with a wire bar. Then the film was heated in the constant temperature bath of 130 degrees Celsius for 120 seconds, to thereby align the discotic liquid crystal compound. Next, this was irradiated with UV rays by using a high-pressure mercury lamp of which output power was 160 W/cm for 40 seconds at 80 degrees Celsius to thereby promote the crosslinking reaction to fix the aligned discotic liquid crystal compound. Next, this was left cooled to room temperature.

Formulation of Coating Liquid for Optically Anisotropic Layer

| | |
|---|---|
| Methyl ethyl ketone | 270 mas. pts. |
| Discotic liquid crystal compound A1 shown below | 100 mas. pts. |
| Agent B1 for controlling alignment at | 1.0 mas. pts. |
| air-interface shown below | |
| Photopolymerization initiator | 3.0 mas. pts. |
| (Irgacure 907, by Chiba Japan) | |
| Sensitizer (Kayacure DETX, by Nippon Kayaku co. ltd) | 1.0 mas. pts. |

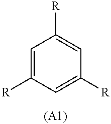

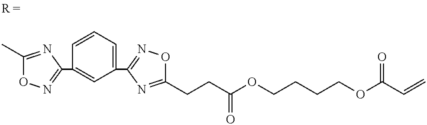

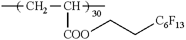

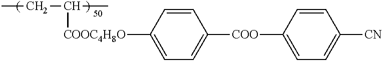

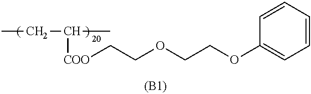

### (3) Fabrication of Polarizing Plate

A polyvinyl alcohol (PVA) film having a thickness of 80 μm was dyed by dipping it in an aqueous iodine solution having an iodine concentration of 0.05% by mass at 30 degrees Celsius for 60 seconds, and then while dipped in an aqueous boric acid solution having a boric acid concentration of 4% by mass, this was stretched in the machine direction by 5 times the original length, and thereafter dried at 50 degrees Celsius for 4 minutes to give a polarizing film having a thickness of 20 micro meters.

The exposed surface of the cellulose acylate film produced in the above (the face thereof not coated with the optically anisotropic layer of the liquid crystal composition) was dipped in an aqueous sodium hydroxide solution (1.5 mol/L) at 55° C., and then fully washed with water to remove sodium hydroxide. Next, this was dipped in an aqueous diluted sulfuric acid solution (0.005 mol/L) at 35 degrees Celsius for 1 minute, then dipped in water to fully remove the aqueous diluted sulfuric acid solution. Finally, the sample was fully dried at 120 degrees Celsius.

The film saponified in the manner as above was combined with a commercial cellulose acetate film that had been saponified also in the same manner as above, the above-mentioned polarizing film was sandwiched between them, and these were bonded together with a polyvinyl alcohol adhesive so that the saponified surfaces of the films were faced to each other, thereby fabricating a polarizing plate. The commercial cellulose acetate film was Fujitac TF80UL (by FUJIFILM Corporation). In this, the polarizing film and the protective film on both surfaces of the polarizing film were produced all as rolls, and therefore, the machine direction of every roll was parallel to each other, and the rolls were unrolled and continuously bonded together. Accordingly, the absorption axis of the polarizer was parallel to the machine direction of the film roll (the casting direction in film formation). In this way, a polarizing plate of Example 1 is fabricated.

### (4) Construction of TN-Mode Liquid crystal Display Device

A pair of polarizing plates was removed from a TN-mode liquid crystal display device (Nippon Acer's AL2216W), and in place of them, the polarizing plate fabricated in the above was bonded to each one on both the viewers' side and the backlight side of the TN-mode liquid crystal cell, using an adhesive, so that its optically anisotropic layer faced the side of the liquid crystal cell. In this, the two polarizing plates were disposed so that the transmission axis of the polarizing plate on the viewers' side was perpendicular to the transmission axis of the polarizing plate on the backlight side. In this way, TN-mode liquid crystal display device of Example 1 was constructed.

### Referential Example 1

### (1) Production of Cellulose Acylate Film

A cellulose acylate film was prepared in the same manner as Example 1.

### (2) Formation of Optically Anisotropic Layer of Liquid Crystal Composition

### (2-1) Saponification of Cellulose Acylate Film:

The obtained cellulose acylate film was subjected to a saponification treatment in the same manner as Example 1.

### (2-2) Formation of Alignment Film

On the cellulose acylate film, a coating liquid for alignment film having the formulation mentioned below was applied in an amount of 24 mL/m², using a wire bar coater of #14. This was dried with hot air at 100 degrees Celsius for 120 seconds. The thickness of the alignment film was 1.2 μm. Next, with the machine direction (MD direction) of the cellulose acylate film regarded as 0 degree, the coated alignment film formed on it was rubbed with rubbing roller of 2000 mm width at a rate of 400 rounds per minutes in the direction of 0 degree. The conveying speed was 40 m/min. Then, the subbed surface was subjected to ultrasonic dust removing.

Formulation of Coating Liquid for Alignment Film

| | |
|---|---|
| Modified polyvinyl alcohol mentioned below | 40 mas. pts. |
| Water | 700 mas. pts. |
| Methanol | 300 mas. pts. |
| Glutaraldehyde (crosslinking agent) | 2 mas. pts. |
| Citrate (AS3, by Sankyo Chemical) | 0.7 mas. pts. |

Modified polyvinyl alcohol

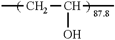

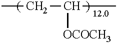

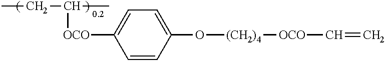

### (2-3) Formation of the Optically Anisotropic Layer

A coating liquid for the optically anisotropic layer having the formulation mentioned below was continuously applied onto the rubbed surface of the alignment film with a wire bar. Then the film was heated in the constant temperature bath of 130 degrees Celsius for 120 seconds, to thereby align the discotic liquid crystal compound. Next, this was irradiated with UV rays by using a high-pressure mercury lamp of which output power was 160 W/cm for 40 seconds at 80 degrees Celsius to thereby promote the crosslinking reaction to fix the aligned discotic liquid crystal compound. Next, this was left cooled to room temperature.

Formulation of Coating Liquid for Optically Anisotropic Layer

| | |
|---|---|
| Methyl ethyl ketone | 270 mas. pts. |
| Discotic liquid crystal compound A2 shown below | 100 mas. pts. |
| Fluorinated aliphatic group-containing copolymer | 0.3 mas. pts. |
| (Megafac F780″ by Dainippon Ink & Chemicals, Inc.) | |
| Photopolymerization initiator | 3.0 mas. pts. |
| (Irgacure 907, by Chiba Japan) | |
| Sensitizer (Kayacure DETX, by Nippon Kayaku co. ltd) | 1.0 mas. pts. |

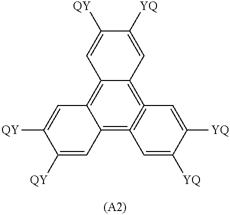

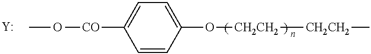

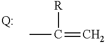

(n = 4, R = H)

### (3) Fabrication of Polarizing Plate

A polarizing plate was fabricated in the same manner as Example 1.

### (4) Construction of TN-Mode Liquid Crystal Display Device

A TN-mode liquid crystal device was constructed in the same manner as Example 1.

### Examples 2 to 7, Comparative Examples 2-3 and 5-10, Referential Example 4

Examples 2 to 7, Comparative Examples 2-3 and 5-10, and Referential

Example 4 were produced in the same manner as in Example 1, except that the additives of the transparent film and the stretching and drying conditions were changed as shown in the following tables respectively. Using each of the obtained films and in the same manner as in Example 1, polarizing plates and TN-mode liquid crystal display devices of were produced.

### Examples 8-10

A polyimide film serving as an alignment film was formed on an ITO electrode-having glass substrate, and the alignment film was rubbed. Thus obtained, two glass substrates were combined in such a manner that the rubbing directions of the two were perpendicular to each other. A liquid-crystal compound (ZLI1132, by Merck) having Δn of 0.1396 was injected into the cell gap, thereby fabricating a 5-inches liquid-crystal cell. In this way, TN-mode liquid crystal cells for Examples 8-10 were produced. The thicknesses of the liquid crystal cell for Examples 8, 9 and 10 were 3.2 μm (Δnd447 nm), 2.86 μm (Δnd399 nm) and 2.15 μm (Δnd300 nm), respectively. The polarizing plate fabricated in Example 1 was bonded to each one on both the viewers' side and the backlight side of each of the TN-mode liquid crystal cells so that the construction was same as Example 1. TN-mode liquid crystal display devices were produced respectively in the same manner as Example 1, except that each of the liquid crystal cells for Examples 8-10 was used. The properties of the retardation films used in Examples 8-10 and the evaluation data of the TN-mode liquid crystal display devices of Examples 8-10 were shown in the following table.

### Examples 11-18

A polyimide film serving as an alignment film was formed on an ITO electrode-having glass substrate, and the alignment film was rubbed. Thus obtained, two glass substrates were combined in such a manner that the rubbing directions of the two were perpendicular to each other. A liquid-crystal compound (ZLI1132, by Merck) having Δn of 0.1396 was injected into the cell gap, thereby fabricating a 5-inches liquid-crystal cell. As one of the glass substrates, a glass substrate having a transfer color filter (by FUJIFILM), which was formed according to the method described in JP-A No. 10-221518, thereon, was used. In this ways the liquid crystal cells for Examples 11-18 were produced respectively. The unevenness of the surface of the transfer color filter was not more than 0.2 micro meters. The thickness of the liquid crystal layer was varied among the R, G and B pixels, as shown in the following table, by varying the thickness of the color filter among the R, G and B domains. The value of Δnd in each of the pixels was shown in the following table. In the description, Δnd_{B} (450 nm) means Δnd at 450 nm of the liquid crystal layer in the B pixel; Δnd_{G} (550 nm) means Δnd at 550 nm of the liquid crystal layer in the G pixel; and Δnd_{R} (630 nm) means And at 630 nm of the liquid crystal layer in the B pixel. The polarizing plate fabricated in Example 1 was bonded to each one on both the viewers' side and the backlight side of each of the TN-mode liquid crystal cells so that the construction was same as Example 1. TN-mode liquid crystal display devices of Examples 11-14 were produced respectively in the same manner as Example 1, except that each of the liquid crystal cells for Examples 11-14 was used. TN-mode liquid crystal display devices of Examples 15-18 were produced respectively in the same manner as Example 1, except that each of the liquid crystal cells for Examples 15-18 was used, and that the transparent support having Rth shown in the following table was used.

Each of the fabricated TN-mode liquid crystal display devices were evaluated according to the following methods and the following criteria.

### (Evaluation of Frontal Cr)

The evaluation of the frontal CR was carried out according to the following criteria.

A: The brightness leakage of the retardation film is less than 40, and the frontal CR is high.

B: The brightness leakage of the retardation film is equal to or more than 40 and less than 80, and the frontal CR is lower than A but higher than C.

C: The brightness leakage of the retardation film is equal to or more than 80, and the frontal CR is lower than A and B.

The brightness leakage of the retardation film was measured as follows. The sample film was disposed between two polarizing plates in Crossed Nichol state, and the lowest brightness was measured by using BM-5 (by TOPCON) while the sample film was rotated.

### (Evaluation of Viewing Angle Cr)

The evaluation of the viewing angle CR was carried out according to the following criteria.

AA: The averaged angle giving CR of 10 or more, which was averaged in the top, bottom, left, and right directions of the liquid crystal display device, was equal to or more than about 80 degrees.

A: The averaged angle giving CR of 10 or more, which was averaged in the top, bottom, left, and right directions of the liquid crystal display device, was equal to or more than 70 degrees and less than 80 degrees.

B: The averaged angle giving CR of 10 or more, which was averaged in the top, bottom, left, and right directions of the liquid crystal display device, was equal to or more than 60 degrees and less than 70 degrees.

C: The averaged angle giving CR of 10 or more, which was averaged in the top, bottom, left, and right directions of the liquid crystal display device, was less than 60 degrees.

By the use of EZ-Contrast 160D (by ELDIM Co.), the viewing angles of the device in the black state (L0) and in the white state (L7) were measured respectively, and the ranges giving CR (white transmittance/black transmittance) of 10 or more were computed regarding top, bottom, left, and right directions.

### (Evaluations of Yellowish Coloration in the Horizontal Direction)

By the use of BM-5 (by TOPCON), the variation of coloration, Δu′v′, was measured at the gray level (L1) giving the 1/7 brightness of the brightness in the white state when the viewing angle was changed from the normal direction to the direction with the polar angle of 60 degrees.

The properties of the retardation films prepared above and the results of the evaluations regarding the liquid crystal display devices were shown in the folloing tables.

| | Referential | | | Comparative | Comparative |
|---|---|---|---|---|---|
| | Example 1 | Example 1 | Example 2 | Example 2 | Example 3 |
| top/bottom tilt angle *1 of | 80/20 | 20/70 | 20/70 | 20/70 | 20/70 |
| Optically Anisotropic Layer | | | | | |
| Re *2 of | 50 | 50 | 30 | 30 | 90 |
| Optically Anisotropic Layer | | | | | |
| Re *2 of | 20 | 20 | 60 | 20 | 20 |
| Transparent Support | (T-axis) | (T-axis) | (T-axis) | (T-axis) | (T-axis) |
| (slow axis) *3 | | | | | |
| Rth *2 of | 100 | 100 | 40 | 100 | 100 |
| Transparent Support | | | | | |
| Minor distribution of | 5 | 3 | 3 | 3 | 3 |
| alignment axes | | | | | |
| Frontal CR | 100 | 60 | 36 | 36 | 108 |
| (brightness leakage of film) | C | B | A | A | C |
| Viewing angle CR | B | AA | AA | C | C |

*1: The top tilt angle (°) means the averaged tilt angle at the air interface side, and the bottom tilt angle (°) means the averaged tilt angle at the alignment-layer interface side.
*2: The unit of Re or Rth is nm.
*3: The term of “T-axis” means the transmission axis of the polarizer; and the indication of “(T-axis)” means that the slow axis of the transparent support is parallel to the transmission axis of the polarizer.

Referential Example 1 is an example wherein the minor distribution of the alignment axes of the optically anisotropic layer is more than 4 and is larger than those found in Examples 1 and 2; Comparative Example 2 is an example not satisfying the relation of (3); and Comparative Example 3 is an example not satisfying the relations of (1)-(3).

| | | Referential | Comparative | | Comparative | Comparative |
|---|---|---|---|---|---|---|
| | Example 3 | Example 4 | Example 5 | Example 4 | Example 6 | Example 7 |
| Optically | Same as Example 1 *1 | | | | | |
| Anisotropic Layer | | | | | | |
| Re *2 of | 20 | 20 | 90 | 50 | 50 | 50 |
| Transparent | (T-axis) | (A- axis) | (T-axis) | (T-axis) | (T-axis) | (T-axis) |
| Support | | | | | | |
| (slow axis) *3 | | | | | | |
| Rth *2 of | 100 | 100 | 100 | 80 | 140 | 30 |
| Transparent | | | | | | |
| Support | | | | | | |
| Frontal CR | B | B | B | B | B | B |
| Viewing angle CR | A | C | C | A | A | C |

*1: The top and bottom tilt angles, Re and Rth of the optically anisotropic layer are same as those of the optically anisotropic layer used in Example 1.
*2: The unit of Re or Rth is nm.
*3: The terms of “T-axis” and “A-axis” mean the transmission axis and the absorption axis of the polarizer respectively; and the indications of “(T-axis)” and “(A-axis)” mean that the slow axis of the transparent support is parallel to the transmission axis and the absorption axis of the polarizer respectively.

Examples 3 and 4 are examples wherein the slow axis of the transparent support is parallel to the transmission axis of the polarizer; on the other hand, Referential Example 4 is an example wherein the slow axis of the transparent support is parallel to the absorption axis of the polarizer. Comparative Example 5 is an example not satisfying the relation of (2); and Comparative Examples 6 and 7 are examples not satisfying the relation of (3).

| | | Comparative | Comparative | | Comparative | |
|---|---|---|---|---|---|---|
| | Example 5 | Example 8 | Example 9 | Example 6 | Example 10 | Example 7 |
| Optically | Same as Example 2*1 | | | | | |
| Anisotropic Layer | | | | | | |
| Re *2 of | 80 | 10 | 140 | 60 | 60 | 60 |
| Transparent | (T-axis) | (T-axis) | (T-axis) | (T-axis) | (T-axis) | (T-axis) |
| Support | | | | | | |
| (slow axis) *3 | | | | | | |
| Rth *2 of | 60 | 60 | 60 | 40 | 100 | 10 |
| Transparent | | | | | | |
| Support | | | | | | |
| Frontal CR | A | A | A | A | A | A |
| Viewing angle CR | A | C | C | A | A | B |

*1: The top and bottom tilt angles, Re and Rth of the optically anisotropic layer are same as those of the optically anisotropic layer used in Example 2.
*2: The unit of Re or Rth is nm.
*3: The term of “T-axis” means the transmission axis of the polarizer; and the indication of “(T-axis)” means that the slow axis of the transparent support is parallel to the transmission axis of the polarizer.

Comparative Examples 8 and 9 are examples not satisfying the relation of (2); and Comparative Example 10 is an example not satisfying the relation of (3).

| | Example 8 | Example 9 | Example 10 |
|---|---|---|---|
| Optically Anisotropic Layer | Same as Example 1 *1 | | |
| Re of Transparent Support | | | |
| Rth of Transparent Support | | | |
| Frontal CR | B | B | B |
| Viewing-angle CR | A | AA | A |
| Panel Transmittance (%) *6 | 107 | 100 | 80 |

| | Example | | Example | | Example | | Example | | Example | | Example | | Example | | Example | |
|---|---|---|---|---|---|---|---|---|---|---|---|---|---|---|---|---|
| | 11 | | 12 | | 13 | | 14 | | 15 | | 16 | | 17 | | 18 | |
| Optically Anisotropic | Same as Example 1 *2 | | | | | | | | | | | | | | | |
| Layer | | | | | | | | | | | | | | | | |
| Re *3 of | 20 | | 20 | | 20 | | 20 | | 20 | | 20 | | 20 | | 20 | |
| Transparent Support | (T-axis) | | (T-axis) | | (T-axis) | | (T-axis) | | (T-axis) | | (T-axis) | | (T-axis) | | (T-axis) | |
| (slow axis) *4 | | | | | | | | | | | | | | | | |
| Rth *2 of | 100 | | 100 | | 100 | | 100 | | 120 | | 120 | | 120 | | 120 | |
| Transparent Support | | | | | | | | | | | | | | | | |
| d_{B} *5 | 2.87 | μm | 2.74 | μm | 2.58 | μm | 2.45 | μm | 3.22 | μm | 3.08 | μm | 2.90 | μm | 2.76 | μm |
| d_{G} *5 | 2.87 | μm | 2.87 | μm | 2.87 | μm | 2.87 | μm | 3.22 | μm | 3.22 | μm | 3.22 | μm | 3.22 | μm |
| d_{R} *5 | 2.87 | μm | 2.95 | μm | 3.06 | μm | 3.15 | μm | 3.22 | μm | 3.32 | μm | 3.44 | μm | 3.54 | μm |
| Δnd_{B}(450 nm) | 440 | nm | 424 | nm | 400 | nm | 380 | nm | 495 | nm | 477 | nm | 450 | nm | 428 | nm |
| Δnd_{G}(550 nm) | 400 | nm | 400 | nm | 400 | nm | 400 | nm | 450 | nm | 450 | nm | 450 | nm | 450 | nm |
| Δnd_{R}(630 nm) | 388 | nm | 401 | nm | 415 | nm | 427 | nm | 437 | nm | 451 | nm | 467 | nm | 480 | nm |

| | | | | | | | | |
|---|---|---|---|---|---|---|---|---|
| Frontal CR | B | B | B | B | B | B | B | B |
| Viewing-angle CR | AA | AA | AA | AA | AA | AA | AA | A |
| Yellowish Coloration | 0.08 | 0.06 | 0.04 | 0.02 | 0.10 | 0.07 | 0.04 | 0.02 |
| in Horizontal | | | | | | | | |
| Direction Δu′v′ | | | | | | | | |
| Panel | 100 | 100 | 100 | 100 | 107 | 107 | 107 | 107 |
| Transmittance *6 | | | | | | | | |

*1: The top and bottom tilt angles, Re and Rth of the optically anisotropic layer are same as those of the optically anisotropic layer used in Example 1. And Re, Rth and the slow axis of the transparent support are same as those of the transparent support used in Example 1.
*2: The top and bottom tilt angles, Re and Rth of the optically anisotropic layer are same as those of the optically anisotropic layer used in Example 1.
*3: The unit of Re or Rth is nm.
*4: The term of “T-axis” means the transmission axis of the polarizer; and the indication of “(T-axis)” means that the slow axis of the transparent support is parallel to the transmission axis of the polarizer.
*5: “d_{B}”, “d_{G}” and “d_{R}” mean the thicknesses of the liquid crystal layer in B, G and R pixels respectively.
*6: The panel transmittance is the value defined by the following formula. Panel Transmittance (%) = (Brightness in the white state)/(Brightness of Backlight) × 100

The brightness in the white state was measured by using “BM-5” (by TOPCOM), and the panel transmittance of Examples 8 and 10 were normalized, assuming that the panel transmittance of Example 9 was 100. The values of the panel transmittance in the tables are normalized data.

From the data shown in the tables, it can be understood that the construction of Example 10 achieved improvement of the panel transmittance and the brightness in the white state without lowering the viewing angle CR. By reducing the backlight brightness, electric power saving may be achieved without lowering the brightness in the white state.

Regarding the TN-mode liquid crystal display devices having the retardation film of the invention, desirable results were obtained in terms of both of the frontal CR and the viewing angle CR. And the data shown above indicate that the yellowish coloration generated in the horizontal direction was reduced by varying the thickness of the liquid crystal layer among the pixels.

1. A retardation film comprising a transparent support, disposed on a surface thereof, an alignment layer and an optically anisotropic layer;
wherein the optically anisotropic layer is formed of a hybrid-aligned liquid crystal composition containing at least one discotic liquid crystal compound;
the averaged tilt angle of discotic molecules of the at least one discotic liquid crystal compound at the alignment-layer interface side of the optically anisotropic layer is equal to or larger than 45°;
the averaged tilt angle of discotic molecules of the at least one discotic liquid crystal compound at the air-interface side of the optically anisotropic layer is equal to or smaller than 45°; and
the transparent support and the optically anisotropic layer satisfy following relations:
Re(DLC)<60 nm (1)
(−0.5)×Re(TS)+40≦Re(DLC)≦(−0.5)×Re(TS)+80 (2)
0.5×Rth(TS)−10≦Re(DLC)≦0.5×Rth(TS)+30 (3)
where Re(DLC) indicates retardation in plane of the optically anisotropic layer; Re(TS) indicates retardation in plane of the transparent support; and Rth(TS) indicates retardation along the thickness direction of the transparent support.

2. The retardation film of claim 1, wherein the minor distribution in alignment axes is equal to or smaller than 4.

3. The retardation film of claim 1, wherein the transparent support is a cellulose acylate film; and the in-plane slow axis of the transparent support is perpendicular to the mechanical direction thereof.

4. A polarizing plate comprising a polarizing film and a retardation film comprising a transparent support, disposed on a surface thereof, an alignment layer and an optically anisotropic layer;
wherein the optically anisotropic layer is formed of a hybrid-aligned liquid crystal composition containing at least one discotic liquid crystal compound;
the averaged tilt angle of discotic molecules of the at least one discotic liquid crystal compound at the alignment-layer interface side of the optically anisotropic layer is equal to or larger than 45°;
the averaged tilt angle of discotic molecules of the at least one discotic liquid crystal compound at the air-interface side of the optically anisotropic layer is equal to or smaller than 45°; and
the transparent support and the optically anisotropic layer satisfy following relations:
Re(DLC)<60 nm (1)
(−0.5)×Re(TS)+40≦Re(DLC)≦(−0.5)×Re(TS)+80 (2)
0.5×Rth(TS)−10≦Re(DLC)≦0.5×Rth(TS)+30 (3)
where Re(DLC) indicates retardation in plane of the optically anisotropic layer; Re(TS) indicates retardation in plane of the transparent support; and Rth(TS) indicates retardation along the thickness direction of the transparent support.

5. The polarizing plate of claim 4, wherein the in-plane slow axis of the retardation films is parallel to the transmission axis of the polarizing film.

6. A liquid crystal display device comprising a retardation film comprising a transparent support, disposed on a surface thereof, an alignment layer and an optically anisotropic layer;
wherein the optically anisotropic layer is formed of a hybrid-aligned liquid crystal composition containing at least one discotic liquid crystal compound;
the averaged tilt angle of discotic molecules of the at least one discotic liquid crystal compound at the alignment-layer interface side of the optically anisotropic layer is equal to or larger than 45°;
the averaged tilt angle of discotic molecules of the at least one discotic liquid crystal compound at the air-interface side of the optically anisotropic layer is equal to or smaller than 45°; and
the transparent support and the optically anisotropic layer satisfy following relations:
Re(DLC)<60 nm (1)
(−0.5)×Re(TS)+40≦Re(DLC)≦(−0.5)×Re(TS)+80 (2)
0.5×Rth(TS)−10≦Re(DLC)≦0.5×Rth(TS)+30 (3)
where Re(DLC) indicates retardation in plane of the optically anisotropic layer; Re(TS) indicates retardation in plane of the transparent support; and Rth(TS) indicates retardation along the thickness direction of the transparent support; and/or
a polarizing plate comprising a polarizing film and a retardation film comprising a transparent support, disposed on a surface thereof, an alignment layer and an optically anisotropic layer;
wherein the optically anisotropic layer is formed of a hybrid-aligned liquid crystal composition containing at least one discotic liquid crystal compound;
the averaged tilt angle of discotic molecules of the at least one discotic liquid crystal compound at the alignment-layer interface side of the optically anisotropic layer is equal to or larger than 45°:
the averaged tilt angle of discotic molecules of the at least one discotic liquid crystal compound at the air-interface side of the optically anisotropic layer is equal to or smaller than 45°; and
the transparent support and the optically anisotropic layer satisfy following relations:
Re(DLC)<60 nm (1)
(−0.5)×Re(TS)+40≦Re(DLC)≦(−0.5)×Re(TS)+80 (2)
0.5×Rth(TS)−10≦Re(DLC)≦0.5×Rth(TS)+30 (3)
where Re(DLC) indicates retardation in plane of the optically anisotropic layer; Re(TS) indicates retardation in plane of the transparent support; and Rth(TS) indicates retardation along the thickness direction of the transparent support.

7. The liquid crystal display device of claim 6, comprising a liquid crystal cell comprising:
a pair of substrates disposing face to face, at least one of them having an electrode thereon;
a liquid crystal layer disposed between the pair of substrates; and
at least three pixels, in which a color filter is disposed, having a different main transparent wavelength from each other,
wherein the thickness of the liquid crystal layer is different between at least two pixels.
